(19) United States
(12) Patent Application Publication
(10) Pub. No.: US 2021/0223144 A1
(43) Pub. Date: Jul. 22, 2021

(54) WATER SAMPLING DEVICE

(71) Applicant: Reign Maker Visual Communications LLC, Callicoon, NY (US)

(72) Inventor: Jessica CHOSID, Callicoon, NY (US)

(73) Assignee: Reign Maker Visual Communications LLC, Callicoon, NY (US)

(21) Appl. No.: 17/067,270

(22) Filed: Oct. 9, 2020

Related U.S. Application Data
(60) Provisional application No. 62/913,786, filed on Oct. 11, 2019.

(51) Int. Cl. G01N 1/12; B64C 39/02; B64D 47/00

(52) U.S. Cl. CPC G01N 1/12; B64C 39/024; B64C 2201/12; B64C 2201/027; B64D 47/00

(57) ABSTRACT

A water sampling device is provided that offsets for buoyancy forces and balances weight on an Unmanned Aerial Vehicle during flight and during the water sampling collection process. The water sampling device can attach to and be removed from an Unmanned Aerial Vehicle even during flight with minimal effort. The water sampling device provides the capability to conduct the collection of water samples at remote locations by use of an Unmanned Aerial Vehicle.

### CROSS REFERENCE TO RELATED APPLICATION

This application claims the benefit under 35 U.S.C. § 119(e) of U.S. Provisional Application No. 62/913,786 filed Oct. 11, 2019 the contents of which are incorporated by reference herein in their entirety.

### BACKGROUND OF THE DISCLOSURE

### 1. Field of the Disclosure

The present disclosure relates to a water sampling device. More particularly, the present disclosure relates to such a water sampling device that connects to an Unmanned Aerial Vehicle (“UAV”).

### 2. Description of the Related Art

Generally, water sampling is a relatively simple mission for UAVs. However, an empty water sampling vessel creates a force (buoyancy) that affects the UAV dynamics and might risk the operation. Other water sampling devices have not been able to offset buoyancy or instead poorly affect pitch, roll and yaw.

Accordingly, there is a need to overcome the disadvantages described above for other water sampling devices.

### SUMMARY

A water sampling device is provided that offsets for buoyancy and balances weight on a UAV. The water sampling device is able to be easily assembled and attached and detached from a UAV, even when the UAV is hovering over a user. The water sampling device can be attached and detached to the UAV even with one hand.

The above and other objects, features, and advantages of the present disclosure will be apparent and understood by those skilled in the art from the following detailed description, drawings, and accompanying claims. As shown throughout the drawings, like reference numerals designate like or corresponding parts.

### BRIEF DESCRIPTION OF THE DRAWINGS

FIG. 1 is a schematic illustration of a UAV connected to an embodiment of a water sampling device according to the present disclosure in a first position.

FIG. 2 is a schematic illustration of the UAV connected to the water sampling device of FIG. 1 in a second position.

FIG. 3 is a bottom perspective view of the water sampling device.

FIG. 4 is an exploded front view of the water sampling device.

FIG. 5 is a partial enlarged view of FIG. 4 showing a bottle, a bottle cage and a partial view of a pole assembly.

FIG. 6 is a partial enlarged view of FIG. 4 showing a partial view of the pole assembly.

FIG. 7 is a partial enlarged view of FIG. 4 showing an adaptor and a partial view of the pole assembly.

FIG. 8 is a partial side view of the pole assembly.

FIG. 9 is a partial top view of the pole assembly.

FIG. 10 is a front view of a first pole member and a first member connector of the pole assembly showing the first pole member in cross-section.

FIG. 11 is a front view of a second pole member and a second member connector of the pole assembly showing the second pole member in cross-section.

FIG. 12 is an exploded top perspective view of the adaptor.

FIG. 13 is a top view of the adaptor in a non-use position.

FIG. 14 is a top view of the adaptor in a use position connected to a UAV that is partially shown.

FIG. 15 is a front view of an example of the water sampling device of the present disclosure.

FIG. 16 is an enlarged partial view of the bottle cage of the water sampling device of FIG. 15.

FIG. 17 is an enlarged partial view of the drone adaptor of the water sampling device of FIG. 15.

FIG. 18 is an enlarged partial view of a second member connector of the water sampling device of FIG. 15.

FIG. 19 is an enlarged partial view of the bottle cage the water sampling device of FIG. 15.

FIG. 20 is a schematic illustration of a UAV connected to another embodiment of the water sampling device according to the present disclosure in a first position.

FIG. 21 is a schematic illustration of the UAV connected to the water sampling device of FIG. 20 in a second position.

FIG. 22 is a bottom perspective view of the water sampling device of FIG. 20.

FIG. 23 is front perspective view of a water sampling bottle loaded into a bottle cage.

FIG. 24 is a front perspective view of the bottle and opened bottle cage of FIG. 23, showing partial enlarged views of the bottle cage.

FIG. 25 is a bottom perspective view of the opened bottle cage of FIG. 23.

FIG. 26 is top perspective view of the water sampling device of FIG. 20, showing partial enlarged views of the bottle cage and pole assembly.

FIG. 27 is a cross section view of a portion of the pole assembly shown in the partial enlarged view of FIG. 26.

FIG. 28 is an exploded bottom perspective view of the water sampling device of FIG. 22, showing partial enlarged views of the bottle cage and pole assembly.

FIG. 29 is perspective view of an internal attachment mechanism of the pole assembly.

FIG. 30 is a side view of a first pole of the pole assembly.

FIG. 31 is a top view of the pole as shown in FIG. 30.

FIG. 32 is a side view of a second pole of the pole assembly.

FIG. 33 is a top view of the pole as shown in FIG. 32.

FIG. 34 is an exploded front view of the water sampling device of FIG. 22, showing partial enlarged cross-sectional views of the pole assembly and UAV connection adaptor.

FIG. 35 is a top view of the UAV connection adaptor of the water sampling device of FIG. 22.

FIG. 36 is an exploded perspective view of the UAV connection adaptor, and a partial view of the pole assembly of the water sampling device of FIG. 22.

FIG. 37 is a top cross-sectional view of the UAV connection adaptor shown in FIG. 35.

FIG. 38 is a partial side cross-section view of the UAV connection adaptor and pole assembly of the water sampling device of FIG. 22.

FIG. 39 is a perspective view of a pulley mechanism housed in the UAV connection adaptor.

FIG. 40 is a partial top view of an opened UAV connection adaptor as shown in FIG. 35.

FIG. 41 is a bottom perspective view of the water sampling device of FIG. 22, showing the UAV connection adaptor connected to UAV bars.

FIG. 42 is a side view of the water sampling device of FIG. 20 showing the pole assembly reversibly bending when the water sampling device is subjected to forces and shows a partial enlarged view of the water sampling device.

### DETAILED DESCRIPTION

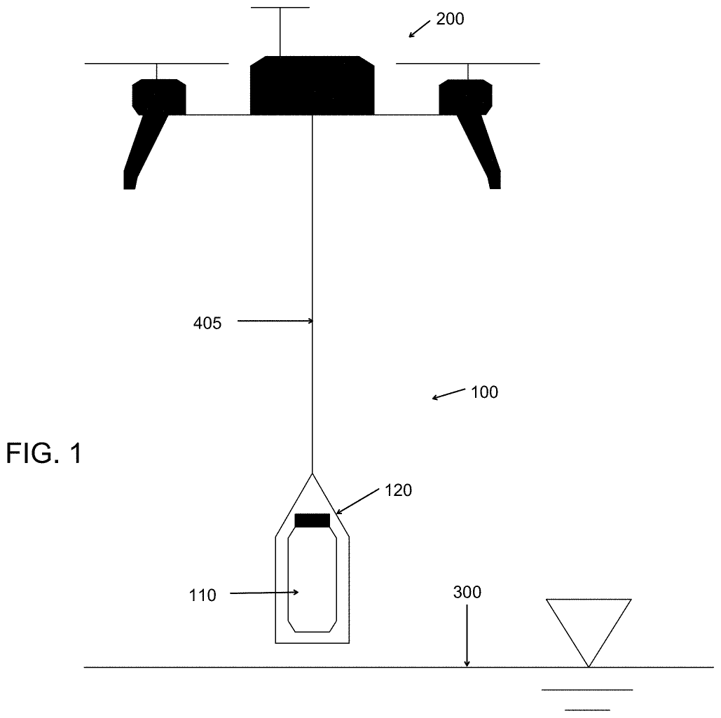

A water sampling device 100 according to an embodiment of the disclosure is shown in FIG. 1. Water sampling device 100 is a device that connects to UAVs, for example, a UAV 200, and enables sampling and surveying of water (or other liquids) reservoirs, for example, reservoir 300. A main advantage of water sampling device 100 is to allow remote material sampling, from any location in reservoir 300. Water sampling device 100 is designed and optimized to fit most industrial grade drones without risking the vehicle dynamics. Water sampling device 100 connects to UAV 200 so that water sampling device 100 moves with UAV 200. UAV 200 can move water sampling device 100 to move a bottle 110 that will hold the collected sample of liquid.

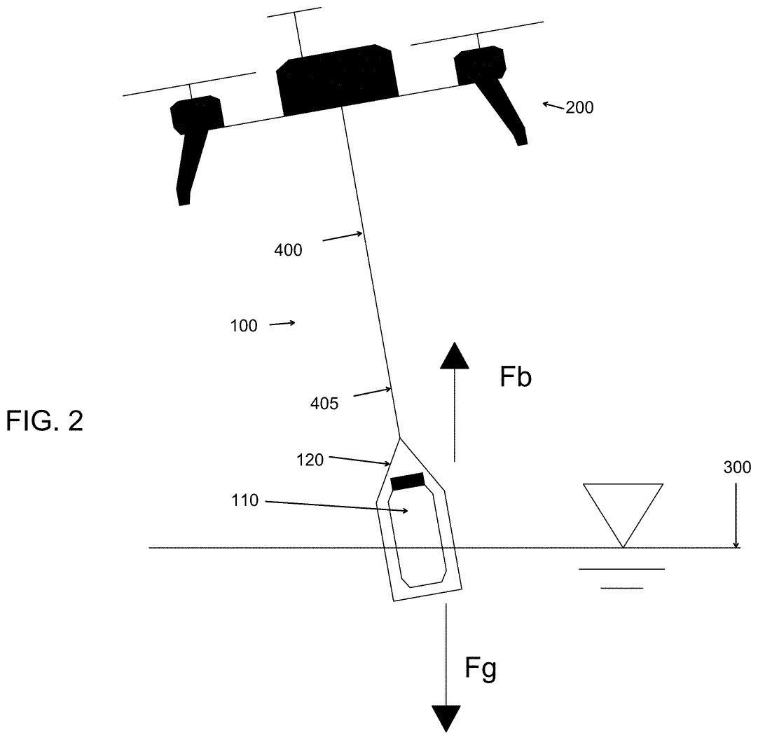

Referring to FIG. 2, water sampling is a relatively simple mission for UAVs, for example, UAV 200. However, after some tests, it shows that an empty water sampling vessel, for example, bottle 110, creates force F_{B} (buoyancy) that is affecting UAV dynamics and might risk the operation. For reference, using a 330 mL sampling bottle as bottle 110 and a 1 meter pole as a pole 405 of a pole assembly 400 of water sampling device 100, will force the UAV 200 to Roll compensate for (max) 2.2-3.3 Nm. To solve this problem, a mass of water sampling device 100 should be slightly higher than force F_{B} that is the buoyancy force. In order to prevent unwanted forces acting on UAV 200, force F_{g} must be greater than a force applied by water sampling device F_{B} as set forth in the following:

F_{B}<F_{g}

F_{B}—Force/buoyancy created due to submerged volume of water sampling device 100
F_{g}— Force that is created due to gravity

F_{B}=ρfVg

ρf—Fluid density (for example, fluid density of water in reservoir 300)
V—Submerged body volume of sampling bottle 110+bottle cage 120
g—Gravity

F_{g}=mg

m—Mass of the bottle cage 120+Mass of bottle 110
g—Gravity

The mass of UAV 200 is considered to be zero due to hovering.

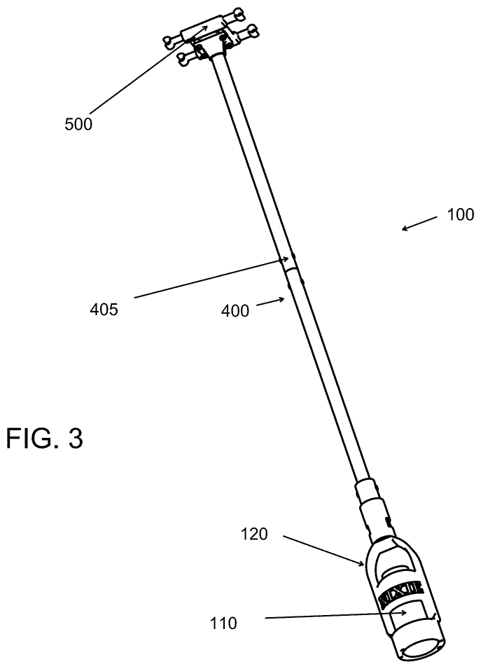

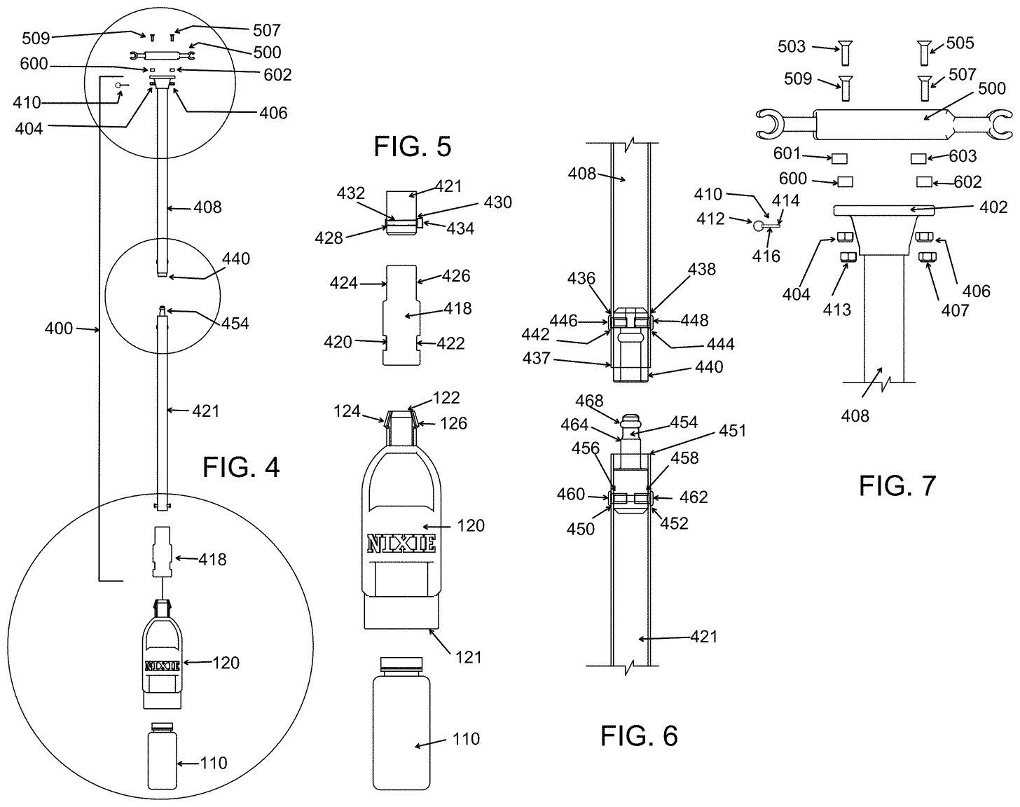

Referring to FIGS. 3 and 4, water sampling device 100 has bottle 110, a bottle cage 120, pole assembly 400 and a device adaptor 500. Water sampling device 100 has, for example, a weight of about 1.3 Kg. Water sampling device 100, for example, is made of plastic that can be recyclable and reusable.

Referring to FIGS. 4 and 5, bottle 110 is a vessel with an opening on a surface facing adaptor 500 that can hold liquids. Bottle 110 is plastic so as to be disposable. Prior techniques for water sampling required a person to submerge their gloved arm in liquid that was being sampled which led to contamination problems. Other water sampling required water sampling bottles, for example, stainless steel bottles, to be sterilized. Stainless steel is undesirably heavy to be carried by UAVs. Further sterilization of stainless-steel bottles takes time as compared to disposable bottles. Alternatively, bottle 110 can be a material that is reusable and can be sterilized between uses.

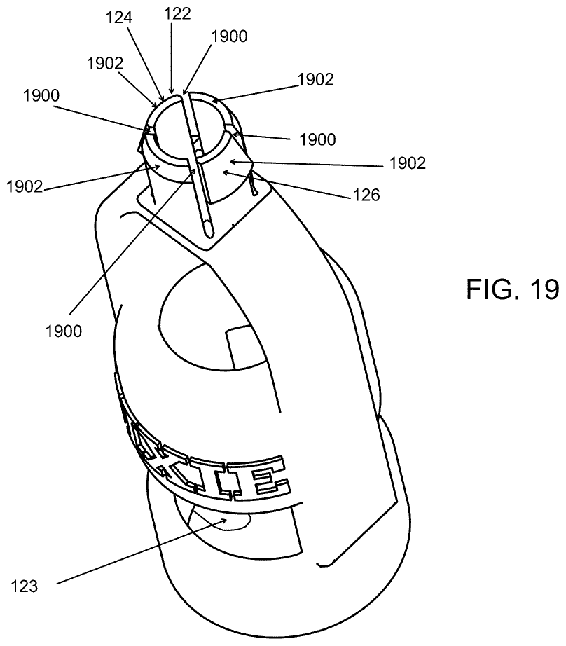

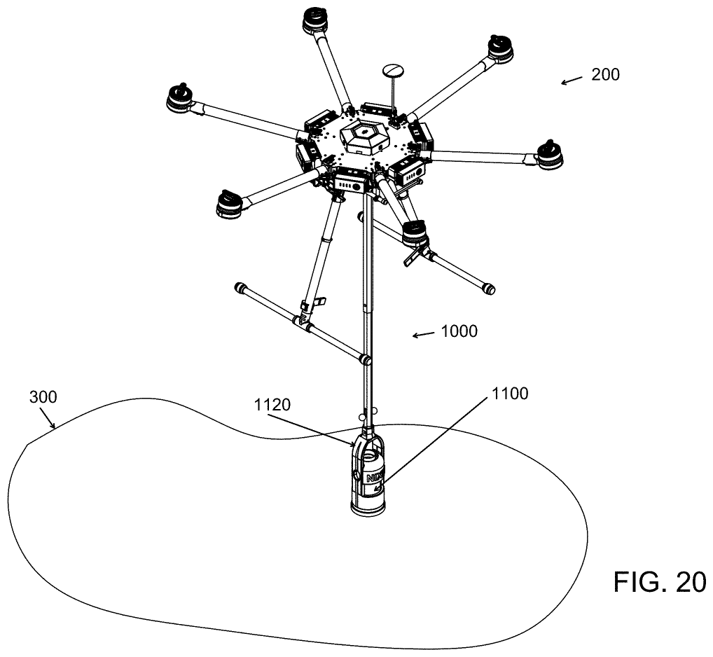

Bottle cage 120 is made from plastic, for example, from Nylon having a density of 1.15 kg/m³. Bottle 110 can be removably secured in bottle cage 120. Bottle 110 is inserted into a bottom 121 of bottle cage 120. For example, bottom 121 of bottle cage 120 has a slightly protruding flexing tab 123 (FIG. 19) that secures the bottle and when pulling back the tab, it allows the bottle 110 to be pulled or pushed from bottle cage 120. Alternatively, a sliding lever (not shown) connected to the bottom of the bottle cage can be pushed towards or pulled away to secure and release the bottle. This would allow the bottle to drop out of the bottle cage without any pulling or pushing needed.

Bottle cage 120 has a cage connector 122 that is connectable to pole connector 418 of pole assembly 400. Cage connector 122 has protrusions 124, 126 that each fit in one of holes 420, 422 through pole connector 418 by snap fit. As shown in FIG. 19, cage connector 122 has slits 1900 forming flaps 1902 that deform inward and overcome a bias of materials of flaps 1902 when inserted into pole connector 418 due to a size of an opening into pole connector 418. When protrusions 124, 126 are out of alignment with holes 420, 422 after inserting cage connector 122 into pole connector 418, cage connector 122 can then be rotated so that protrusions 124, 126 become aligned with holes 420, 422 and flaps 1902 move outward due to the bias of the materials of flaps 1902 to insert protrusions 124, 126 into holes 420 and 422 respectively; thereby maintaining a connection between cage connector 122 and pole connector 418. To remove cage connector 122 from pole connector 418, a user's fingers can be inserted into each of holes 420, 422 to move flaps 1902 having protrusions 124, 126 toward one another to move protrusions 124, 126 out of holes 420, 422 so that cage connector 122 and pole connector 418 can move away from one another. Pole assembly 400 has a first pole member 408 and a second pole member 421. Pole connector 418 is a tube that is open inside to receive a portion of second pole member 421. Pole connector 418 has holes 424, 426 on an end on an opposite side of pole connector 418 that has holes 420, 422. Second pole member 421 has holes 428, 430. Holes 424, 426 through opposite sides of pole connector 418 and holes 428, 430 through opposite sides of second pole member 421 align allowing a bolt 432 to pass through each of holes 424, 426 and holes 428, 430 and receive a nut 434 to connect pole connector 418 to second pole member 421.

Referring to FIGS. 4, 6 and 10, first pole member 408 has holes 436, 438 on opposite sides of end 437. Pole assembly 400 has a first member connector 440 that has holes 442, 444 on opposite sides. Hole 436 through first pole member 408 and hole 442 through first member connector 440 align to allow a screw 446 to pass through each. Hole 438 through first pole member 408 and hole 444 through first member connector 440 align to allow a screw 448 to pass through each to connect first pole member 408 to first member connector 440.

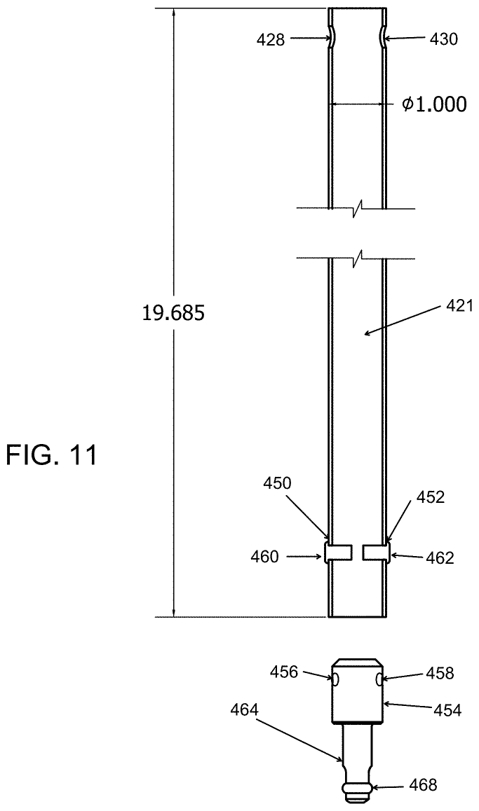

Referring to FIGS. 4, 6 and 11, second pole member 421 has holes 450, 452 on opposite sides of end 451. Pole assembly 400 has a second member connector 454 that has holes 456, 458 on opposite sides. Hole 450 through second pole member 421 and hole 456 through second member connector 454 align to allow a screw 460 to pass through each, and hole 452 through second pole member 421 and hole 458 through second member connector 454 align to allow a screw 462 to pass through each to connect second pole member 421 to second member connector 454.

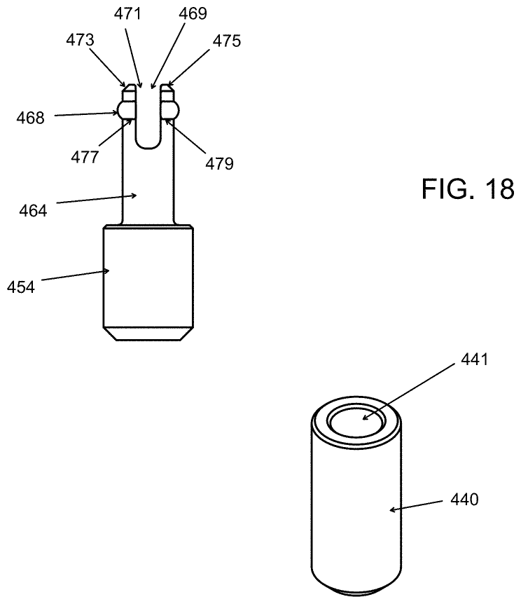

Second member connector 454 has an extension 464 having a protrusion 468 at an end opposite a location of holes 456, 458. First member connector 440 has a recess that has a shape complementary to protrusion 468 and a portion of extension 464. Protrusion 468 and the portion of extension 464 are inserted in the recess of first member connector 440 to connect first member connector 440, and second member connector 454 by snap fit to connect first pole member 408 and second pole member 421. As shown in FIG. 18, extension 464 has a slot 469 forming a gap 471 between a first arm 473 and a second arm 475. A first portion 477 of protrusion 468 extends from first arm 473. A second portion 479 of protrusion 468 extends from second arm 475. When extension 464 is inserted into first member connector 440, first arm 473 and second arm 475 deform toward one another and overcome a bias of materials of first arm 473 and second arm 475 due to a size of the opening 441 in first member connector 440. When extension 464 enters the recess of first member connector 440, first arm 473 and second arm 475 move outward away from one another due to the bias of the materials of first arm 473 and second arm 475 to maintain protrusion 468 in the recess of first member connector 440 and maintaining second member connector 454 connected to first member connector 440. A shape of protrusion 468 allows protrusion 468 to rotate in the recess of first member connector 440 so that second member connector 454 can rotate relative to first member connector 440. To disconnect first member connector 440 and second member connector 454, a force is applied to first member connector 440 and/or second member connector 454 to pull first member connector 440 and second member connector 454 apart thereby moving protrusion 468 against the recess of first member connector 440 and moving first arm 473 and second arm 475 toward one another so that protrusion 468 can be moved out of the recess of first member connector 440 to disconnect second member connector 454 from first member connector 440. Pole assembly 400 having two parts, namely, first pole member 408 and second pole member 421, allow for easy handling and shipping.

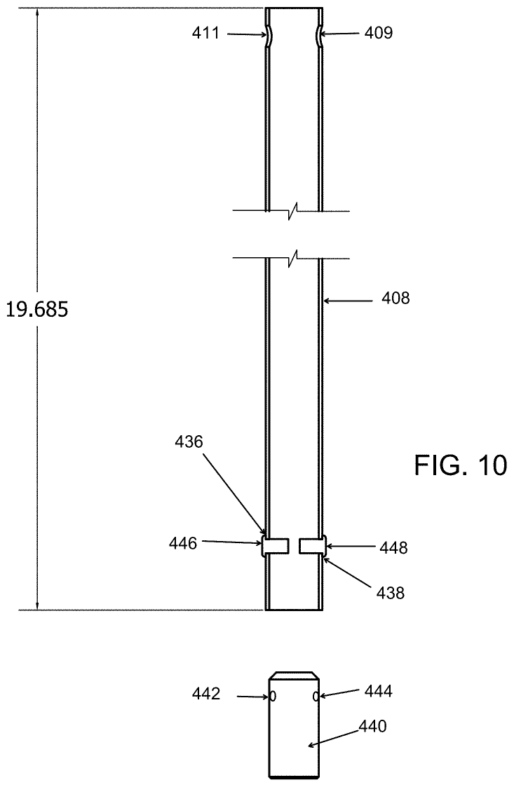

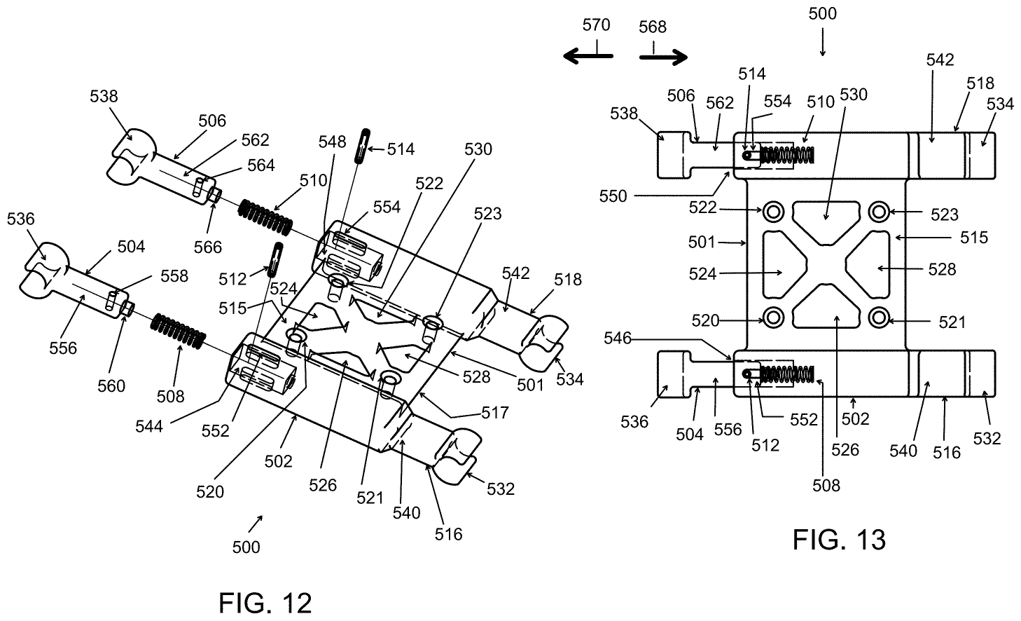

Referring to FIGS. 4 and 7, device adaptor 500 is connected to pole assembly 400 by bolts 509, 503, 507, 505 that each pass through one of holes 520, 521, 522, 523 (FIG. 12), respectively, through adaptor 500, and then through one of dampers 600, 601, 602, 603, and thereafter through one of four holes in pole adaptor 402 of pole assembly 400, and are secured in place by one of nuts 404, 413, 406, 407, respectively. Each of bolts 509, 503, 507, 505 is secured to one of nuts 404, 413, 406, 407, respectively, to connect device adaptor 500 to pole assembly 400. Water sampling device 100 has dampers 600, 601, 602, 603 between pole adaptor 402 and device adaptor 500 when assembled. Dampers 600, 601, 602, 603 act as shock absorbers between pole adaptor 402 and device adaptor 500 when assembled. Dampers 600, 601, 602, 603 can become compressed between pole adaptor 402 and device adaptor 500 when UAV 200 is in flight and when bottle cage 120 is submerged and can thereby absorb shock by mitigating the forces acting on UAV 200 during flight. Pole adaptor 402 is connected to a first pole member 408 by a pin 410. Pin 410 has a gripping member 412 on a first side and a spring-loaded pair of retractable members 414 on opposite sides of a second side. Retractable members 414 retract into a pin body 416 when a force is applied to overcome a force applied by one or more springs urging retractable members 414 outward to extend out of pin body 416 when a force less than the force applied by one or more springs is applied. As shown in FIG. 10, holes 411, 409 through opposite sides of first pole member 408 and holes through opposite sides of pole adaptor 402 align allowing retractable members 414 of pin 410 to retract when passing therethrough and extend thereafter to connect device adaptor 500 to pole assembly 400.

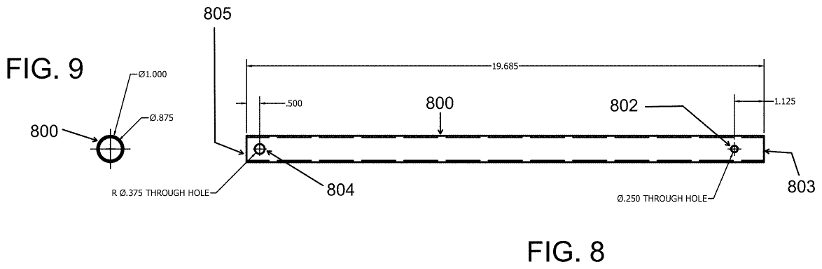

Referring to FIGS. 8 and 9, a universal pole member 800 can be used as both first pole member 408 and second pole member 421 so that first pole member 408 is the same as second pole member 421 turned upside-down. Universal pole member 800 can be about 19.685 inches long, about 1 inch wide, and have a thickness of about 0.125 inches. Holes 802 can be about 1.125 inches from a first end 803. Holes 802 can be 0.25 inches in diameter. Holes 804 can be about 0.500 inches from a second end 805. Holes 804 can be 0.375 inches in diameter.

Referring to FIGS. 12 and 13, device adaptor 500 has an adaptor body 502, a first movable arm 504, a second movable arm 506, a first spring 508, a second spring 510, a first rod 512 and a second rod 514. Adaptor body 502 has a first fixed arm 516 and a second fixed arm 518. Adaptor 500 has holes 520, 521, 522, 523 from an upper surface 515 through a lower surface 517 in a central portion 501 of adaptor body 502. Adaptor 500 has apertures 524, 526, 528, 530 around a center of adaptor body 502 forming a cross shape.

Apertures 524, 526, 528, 530 form the cross shape, or in other words, an X design, and allow adaptor 500 to maximize strength, yet be easy to manufacture while using the least amount of material. Using the least amount of material for adaptor 500 keeps payload weight down, which is desirable with UAVs, as well as helps control manufacturing costs. Using the least amount of material uses the least amount of plastic as possible.

First fixed arm 516 has a fastener 532. Second fixed arm 518 has a fastener 534. First movable arm 504 has a fastener 536. Second movable arm 506 has a fastener 538. Each of fasteners 532, 534, 536, 538 is C-shaped. Fastener 532 of first fixed arm 516 extends from a support 540 that extends from central portion 501. Fastener 534 of second fixed arm 518 extends from a support 542 that extends from central portion 501. Adaptor body 502 has a first cavity 544 with an opening 546 opposite first fixed arm 516. Adaptor body 502 has a second cavity 548 with an opening 550 opposite second fixed arm 518. Adaptor body 502 has first track openings 552 through each of upper surface 515 and lower surface 517 of support 540. Adaptor body 502 has a second track openings 554 through each of upper surface 515 and lower surface 517 of support 542. Fastener 536 of first movable arm 504 extends from a support 556. Support 556 has a hole 558 therethrough and a protrusion 560 on a surface opposite fastener 536. Fastener 538 of second movable arm 506 extends from a support 562. Support 562 has a hole 564 therethrough and a protrusion 566 on a surface opposite fastener 538.

As shown in FIG. 13, first spring 508 is positioned in first cavity 544. Protrusion 560 of first movable arm 504 is then fit in first spring 508 and first movable arm 504 is moved in a direction 568 to overcome an outward bias of first spring 508 that is in a direction 570. Once hole 558 in support 556 of first movable arm 504 is moved into alignment with first track openings 552, first rod 512 is inserted through first track opening 552 through upper surface 515, through hole 558 and through first track opening 552 through lower surface 517 to maintain a portion of support 556 in first cavity 544 to connect first movable arm 504 in adaptor body 502.

Second spring 510 is positioned in second cavity 548. Protrusion 566 of second movable arm 506 is then fit in second spring 510 and second movable arm 506 is moved in direction 568 to overcome an outward bias of second spring 510 that is in a direction 570. Once hole 564 through support 562 of second movable arm 506 is moved into alignment with second track openings 554, second rod 514 is inserted through second track opening 554 through upper surface 515, through hole 564 and through second track opening 554 through lower surface 517 to maintain a portion of support 562 in second cavity 544 to connect second movable arm 506 in adaptor body 502.

During operation, a force that overcomes the bias of first spring 508 is applied to fastener 536 of first movable arm 504 to move first movable arm 504 in direction 568. Releasing of the force that overcomes the bias of first spring 508 moves first movable arm 504 back in direction 570. A force that overcomes the bias of second spring 510 is applied to fastener 538 of second movable arm 506 to move second movable arm 506 in direction 568. Releasing of the force that overcomes the bias of second spring 510 applied to fastener 538 of second movable arm 506 moves second movable arm 506 back in direction 570.

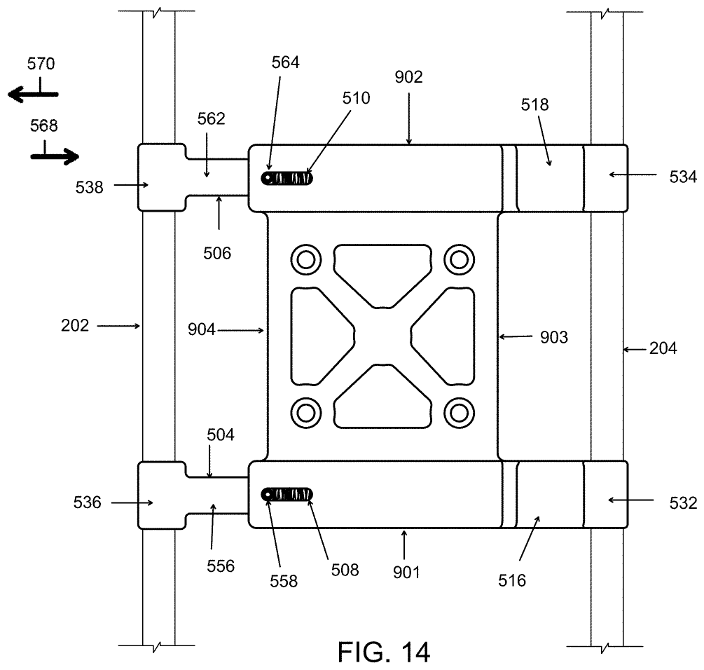

Referring to FIG. 14, UAV 200 has a first bar 202 and a second bar 204. During operation, UAV 200 hovers while water sampling device 100 is connected. Second bar 204 is received by fastener 532 of first fixed arm 516 and fastener 534 of second fixed arm 518. Then, fastener 536 of first movable arm 504 and fastener 538 of second movable arm 506 are pressed against first bar 202 to apply a force that overcomes the bias of first spring 508 applied to fastener 536 of first movable arm 504 to move first movable arm 504 in direction 568 and apply a force that overcomes the bias of second spring 510 applied to fastener 538 of second movable arm 506 to move second movable arm 506 in direction 568 so that fastener 536 of first movable arm 504 and fastener 538 of second movable arm 506 receive first bar 202. After fastener 536 of first movable arm 504 and fastener 538 of second movable arm 506 receive first bar 202, the bias of first spring 508 urges fastener 536 of first movable arm 504 against first bar 202 and the bias of second spring 510 urges fastener 538 of second movable arm 506 against first bar 202. Also, the bias of first spring 508 and the bias of second spring 510 also urges first fixed arm 516 and second fixed arm 518 against second bar 204, to maintain adaptor 500 connected to first bar 202 and second bar 204. Device adaptor 500 has a first side 901, a second side 902, a third side 903 and a fourth side 904 as shown on FIG. 14.

Alternatively, fastener 536 of first movable arm 504 and fastener 538 of second movable arm 506 receive first bar 202. Then, a force is applied to adaptor 500 that overcomes the bias of first spring 508 applied to fastener 536 of first movable arm 504 to move first movable arm 504 in direction 568 and that overcomes the bias of second spring 510 applied to fastener 538 of second movable arm 506 to move second movable arm 506 in direction 568 so that fastener 532 of first fixed arm 516 and fastener 534 of second fixed arm 518 can receive second bar 204.

Accordingly, no screws, bolts or the like are needed to connect water sampling device 100 to UAV 200. A user can grasp pole assembly 400 with one hand to connect adaptor 500 to first bar 202 and second bar 204 as described herein.

UAV 200 hovers while water sampling device 100 is disconnected. Adaptor 500 can be removed from first bar 202 and second bar 204, by the user applying a force in direction 570 allowing fastener 532 of first fixed arm 516 and fastener 534 of second fixed arm 518 to separate from second bar 204, then, fastener 536 of first movable arm 504 and fastener 538 of second movable arm 506 can disconnect from first bar 202 separating adaptor 500 from UAV. A user can grasp pole assembly 400 with one hand to disconnect adaptor 500 to first bar 202 and second bar 204 as described herein. Accordingly, adaptor 500 is a quick release adaptor that can be connected and disconnected to a UAV by one hand.

An additional failsafe can be added to adaptor 500 in case the spring loaded first movable arm 504 and second movable arm 506 fail in mid-air, although they should not fail as each individual spring of first spring 508 and second spring 510 would have to fail simultaneously and they are independent of each other. This provides additional safety redundancy to water sampling device 100. An additional failsafe can be added to the bottom of bottle cage 120.

If UAV 200 does not have a first bar 202 and a second bar 204, then UAV can be subsequently modified to include first bar 202 and second bar 204.

Water sampling device 100 is designed to plunge below the surface because it is important not to gather the surface water for most water sampling testing. Other water sampling devices have not been able to offset buoyancy or effect pitch, roll and yaw poorly. These other devices simply float on the water which is undesirable. Water sampling device 100, besides for offsetting buoyancy, also balances weight on UAV 200 properly. As discussed above, water sampling is a relatively simple mission for UAVs. However, after some tests, it shows that an empty water sampling vessel creates force (buoyancy) that is affecting the UAV dynamics and might risk the operation. For reference, using a 330 mL sampling bottle and a 1 meter pole, will force the UAV to Roll compensate for 3.3 Nm. To solve this problem, the mass of water sampling device 100 should be slightly higher than the buoyancy force. Roll is one of the forces in aerodynamics. Pitch, Roll and Yaw, are also known as the “Principal Axes” or “Axes of Rotation”, that include: Lateral Axis (Pitch), Longitudinal Axis (Roll) and Vertical Axis (Yaw). It is important that the UAV, with water sampling device 100, not compromise the flying safety (pitch, roll, yaw) of the drone.

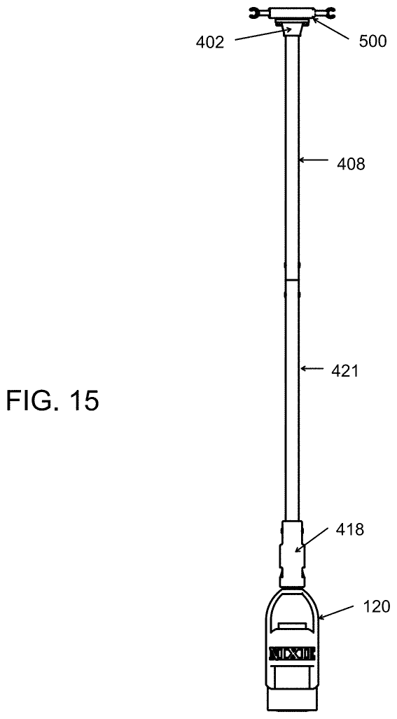

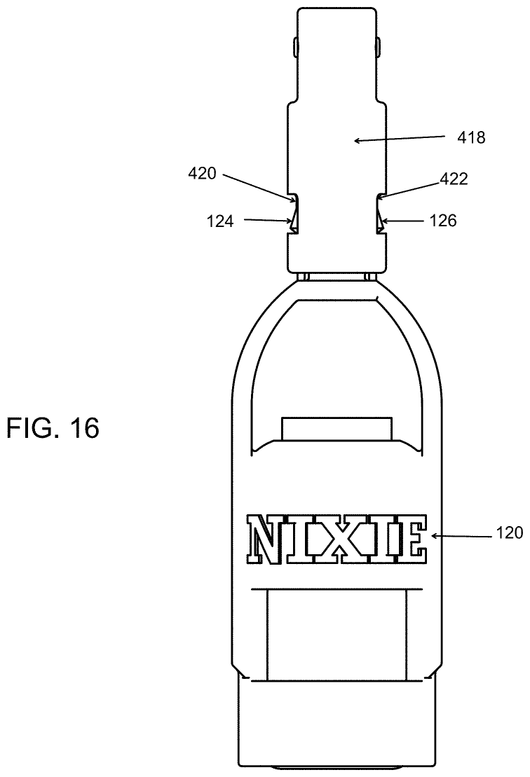

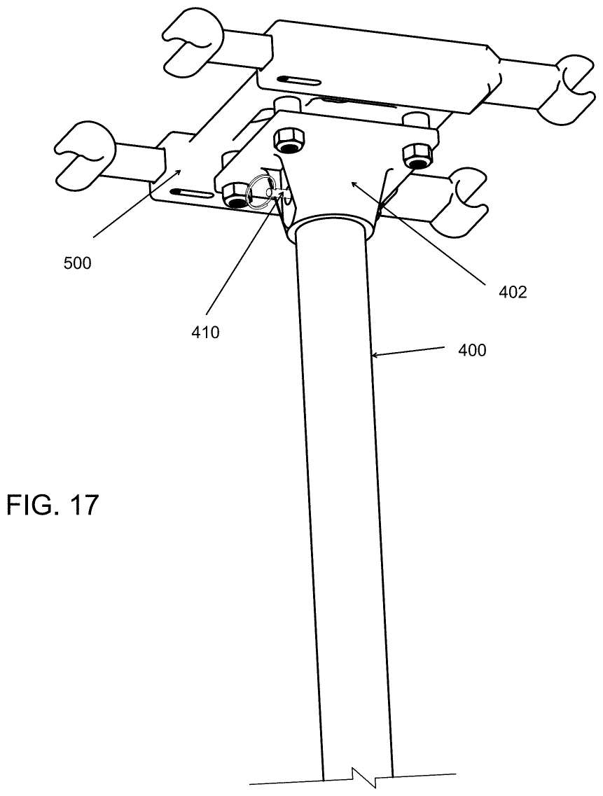

FIGS. 15-17 are examples of water sampling device 100 of the present disclosure as described herein. FIGS. 18-19 are described above.

A water sampling device 1000 according to a preferred embodiment of the disclosure is shown in FIG. 20. Water sampling device 1000 is a device that connects to UAVs, for example, a UAV 200, and enables sampling and surveying of water (or other liquids) reservoirs, for example, reservoir 300. A main advantage of water sampling device 1000 is to allow remote material sampling, from any location in reservoir 300. Water sampling device 1000 is designed and optimized to fit most industrial grade drones (UAVs) without risking the vehicle dynamics. Water sampling device 1000 connects to UAV 200 so that water sampling device 1000 moves with UAV 200. UAV 200 can move water sampling device 1000 to move a bottle 1110 that will hold the collected sample of liquid. Bottle 1110 is contained within a bottle cage 1120.

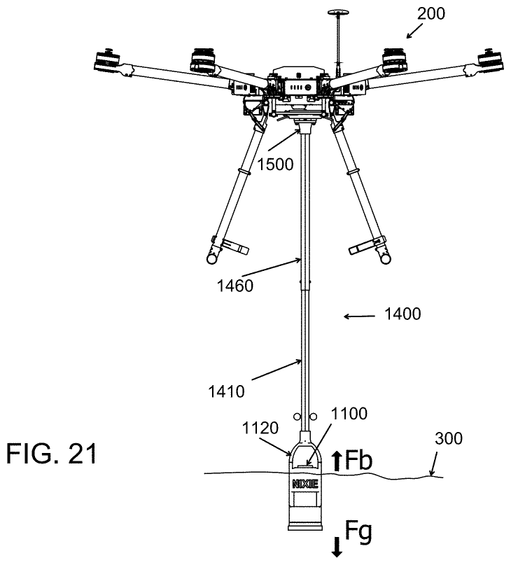

Referring to FIG. 21, water sampling is a relatively simple mission for UAVs, for example, UAV 200. However, after some tests, it shows that an empty water sampling vessel, for example, bottle 1110, creates force F_{B} (buoyancy) that is affecting UAV dynamics and might risk the operation. For reference, using a 500 mL sampling bottle as bottle 110 and a 1 meter pole assembly 1400 of water sampling device 1000, will force the UAV 200 to Roll compensate for (max) 3.5-5 Nm To solve this problem, a mass of water sampling device 1000 should be slightly higher than force F_{B} that is the buoyancy force. In order to prevent unwanted forces acting on UAV 200, force F_{g} must be greater than a force applied by water sampling device F_{B} as set forth in the following:

F_{B}<F_{g}

F_{B}—Force/buoyancy created due to submerged volume of water sampling device 1000
F_{g}— Force that is created due to gravity

F_{B}=ρfVg

ρf—Fluid density (for example, fluid density of water in reservoir 300)
V—Submerged body volume of sampling bottle 1110+bottle cage 1120
g—Gravity

F_{g}=mg

m—Mass of the bottle cage 1120+Mass of bottle 1110
g—Gravity

The mass of UAV 200 is considered to be zero due to hovering.

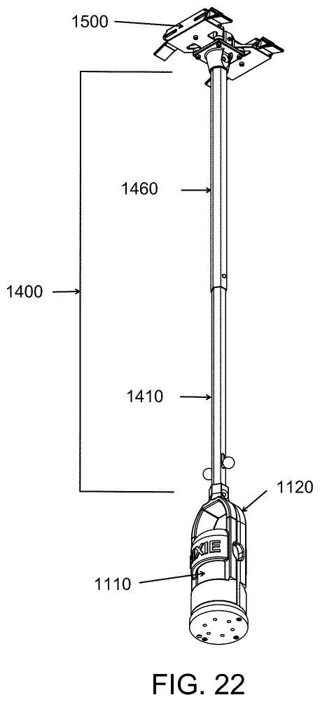

Referring to FIG. 22, water sampling device 1000 has bottle 1110, a bottle cage 1120, pole assembly 1400 and a device adaptor 1500. Water sampling device 1000 has, for example, a weight of about 1.215 Kg Water sampling device 1000, for example, is made of plastic that can be recyclable and reusable and from carbon fiber. Adaptor 1500, bottle 1110 and bottle cage 1120 can be made from plastic such as Nylon. The poles 1410 and 1460 can be made from carbon fiber.

Pole assembly 1400 includes a first pole 1410 that connects the bottle cage 1120 and a second pole 1460. Second pole 1460 connects to device adaptor 1500. Device adaptor 1500 is able to connect to UAV 200. In some embodiments, poles 1410 and 1460 can be hollow rounded cylindrical poles or hollow hexagonal poles.

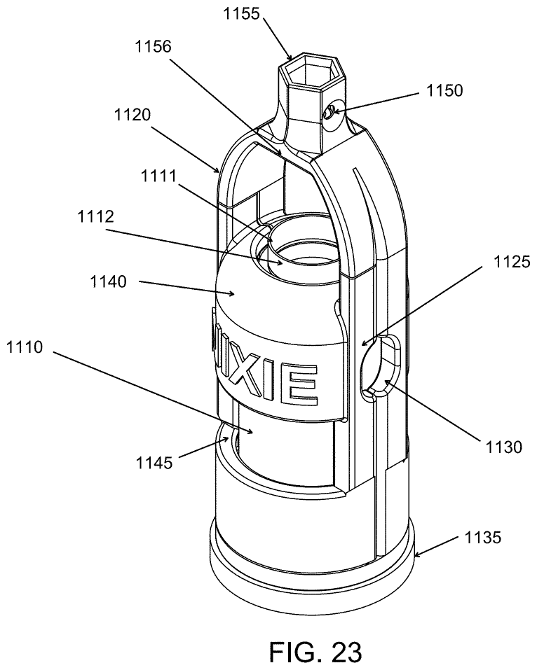

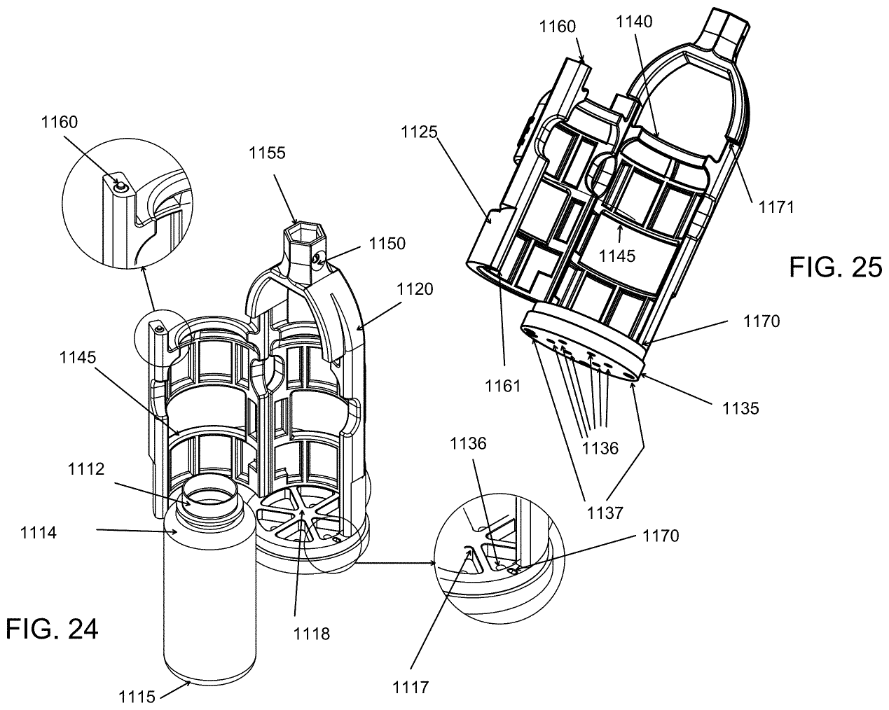

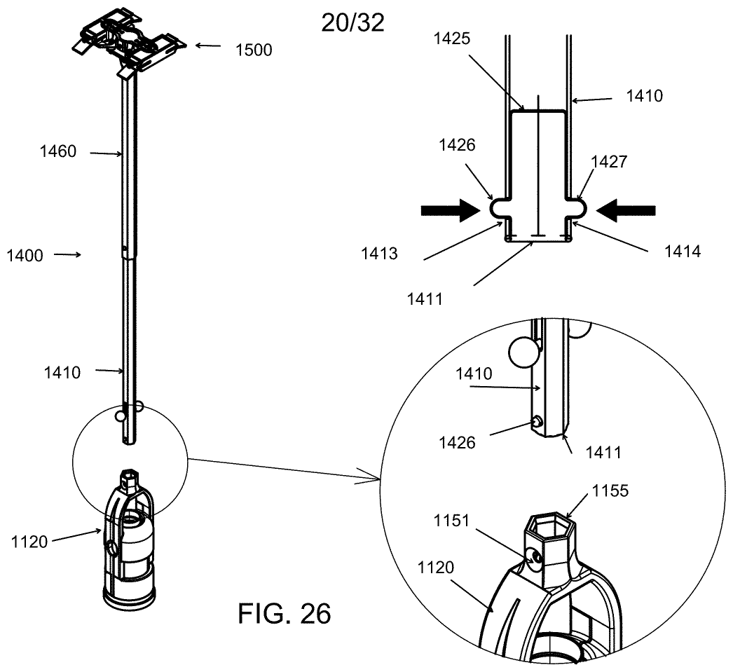

Referring to FIGS. 23-25, bottle 1110 is a vessel with an opening 1111 that can hold liquids, that when inserted into bottle cage 1120, opening 1111 faces adaptor 1500, and the bottom 1115 of bottle 1110 rests on an interior base 1118 of bottle cage 1120. Bottle 1110 is plastic so as to be disposable. In some embodiments bottle 1110 can be glass to collect certain types of liquid samples. Bottle 1110 can be adapted to be made of different materials and can be made into different sizes based on various needs. Alternatively, bottle 1110 can be a material that is reusable and can be sterilized between uses.

Bottle cage 1120 is made from plastic, for example, from having a density of 1.15 kg/m³, or in the case of SLS 3D printed Nylon a density of 0.95 kg/m³. Bottle 1110 can be removably secured in bottle cage 1120, by opening bottle cage door 1125, inserting bottle 1110 in bottle cage 1120 and closing cage door 1125. Bottle cage door 1125 and bottle cage 1120 have a cutout portion 1130 that a user hands can use to grasp and open and close bottle cage door 1125. Bottle cage 1120 can also have a cutout 1145 so as to reduce the weight of bottle cage 1120. Bottle cage 1120 also has a weighted base 1135, made of a denser material than the rest of bottle cage 1120, so that the center of gravity of the bottle cage 1120 becomes shifted towards the bottom or base of bottle cage 1120. Weighted base 1135 is advantageous because the additional weight allows device 1000 to more easily penetrate the surface of a liquid reservoir 300, by offsetting the buoyancy forces of the empty bottle 1110. Weighted base 1135 can also serve as a protection for cage 1120 and bottle 1110, against device 1000 hitting hard objects such as rocks or debris in the vicinity of the area targeted for liquid sample collection. In some embodiments, weighted based 1135 can have one or more drain holes 1136 so that when bottle cage 1120 becomes submerged in a liquid, the liquid can drain out through the holes 1136 when the bottle cage 1120 is lifted out of the liquid by UAV 200. In some embodiments, base 1135 has six holes 1136. Base 1118 can have multiple openings 1117 providing access to drains holes 1136 in base 1135. Openings 1117 also reduce the weight of bottle cage 1120. In some embodiments, weighted base 1135 is connected to the base 1118 of cage 1120 by bolts 1137.

Bottle cage 1120 has a cage connector 1155 that is connectable to pole 1410 of pole assembly 1400. Cage connector 1155 has holes 1150 and 1151 for connection to pole 1410. Cage connector 1155 can be hexagonally shaped and sized so as to accept the insertion and detachable connection of pole 1410, that can also be hexagonally shaped. Bottle cage 1120 has a retaining portion 1140 that curves inward toward the center of bottle cage 1120, and surrounds and retains bottle lip 1112 and curved portion 1114 of bottle 1110. Retaining portion 1140 ensures that bottle 1110 does not move about freely within cage 1120, while also ensuring that opening 1111 of bottle 1110 is not obstructed, so that when bottle 1110 is submerged, liquids can enter opening 1111.

Bottle cage door 1125 has identical locking mechanisms 1160 and 1161 that are capable of being biased into cage door 1125 from a first starting or non-biased position when cage 1125 is being closed. When cage door 1125 is fully closed, as shown in FIG. 23, locking mechanisms 1160 and 1161 are able to return to their original starting or non-biased positions and become retained in identical recesses 1170 and 1171 that are in bottle cage 1120, thereby preventing bottle cage door 1125 from opening during operation and movement of UAV 200. Bottle cage door 1125 is capable of being opened by a user applying sufficient force to pull cage door 1125 open, thereby causing locking mechanisms 1160 and 1161, to be again biased into cage door 1125, and releasing the locking mechanisms from recesses 1170 and 1171. In some embodiments, locking mechanisms 1160 and 1161 are spring loaded ball bearings or spring-loaded plungers capable of being retained in cage door 1125. In some embodiments, locking mechanisms 1160 and 1161 can be made of stainless steel.

Referring to FIGS. 26-27, pole 1410 has a first end 1411, that is insertable into cage connector 1155. Pole 1410 contains holes 1413 and 1414 on opposing parallel surfaces near first end 1411, through which locking pins 1426 and 1427 of locking mechanism 1425 protrude through. In some embodiments, locking mechanism 1425 is a single flexible unitary mechanism so that when first end 1411 is first inserted into cage connector 1155, locking pins 1426 and 1427 are biased inward towards the center of pole 1410. In some embodiments, locking mechanism 1425 can be spring steel button pins that are made of stainless steel and use a spring force to produce the biasing force described above. Once pole 1410 is fully inserted into cage connector 1155, locking pins 1426 and 1427 return to their original unbiased positions, and protrude through openings 1150 and 1151 of cage connector 1155, thereby locking pole 1410 to bottle cage 1120. To release pole 1410 from bottle cage 1120, locking pins 1426 and 1427 can be biased or pressed inward, and pole 1410 can be pulled out of cage connector 1155.

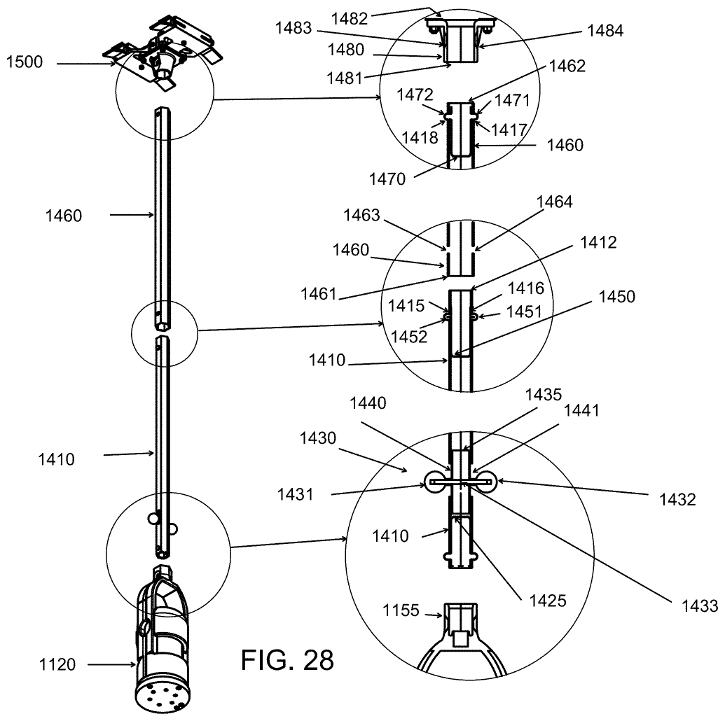

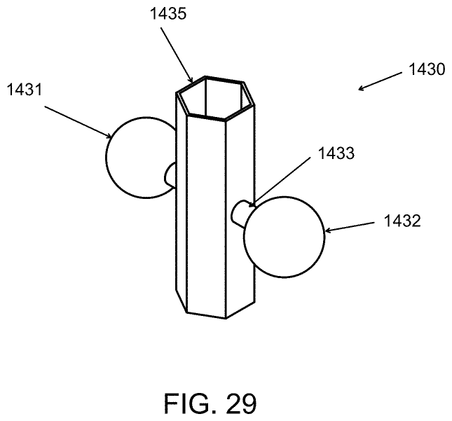

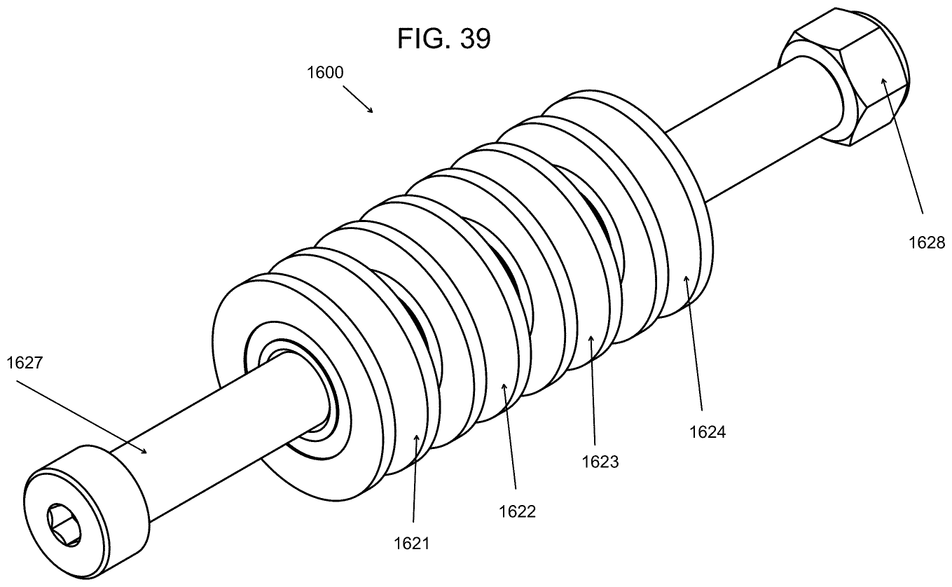

Referring to FIG. 28, pole 1410 contains within it, an attachment mechanism 1430 that is capable of parallel movement with respect to the length of pole assembly 1400. Attachment mechanism 1430 has a center pole piece 1435, that is hollow and can be hexagonal. Attachment mechanism 1430 is also shown in FIG. 29. Attachment mechanism 1430 is able to move towards and away from bottle cage 1120, while in pole 1410, with its movement being limited by the length of slots 1440 and 1441 as shown in FIG. 30. Attachment mechanism 1430 has a center rod 1433 on which a first and second grip 1431 and 1432 are attached thereon. When mechanism 1430 is placed in pole 1410, center rod 1433 and grips 1431 and 1432 protrude from slots 1440 and 1441. One or more pulley cables are able to be attached to center rod 1433, as shown in FIG. 38. In some embodiments, four pulley cables are attached to center rod 1433.

Referring to FIG. 28, pole 1410 has a second locking mechanism 1450 that is identical to the first locking mechanism 1425. Locking mechanism 1450 has locking pins 1451 and 1452 that protrude from holes 1416 and 1415 that are located on opposite surfaces of pole 1410 and is located near the second end 1412 of pole 1410. Locking pins 1451 and 1452 are able to be biased inward towards the center of pole 1410, so that pole 1410 can be inserted into pole 1460. Pole 1460 has a first end 1461 into which the second end 1412 of pole 1410 is inserted. Once the second end 1412 is fully inserted into first end 1461, the locking pins 1451 and 1452 are able to return back to their original unbiased positions and protrude through openings 1464 and 1463 of pole 1460, thereby locking poles 1460 and 1410 together. To release pole 1410 from pole 1460, locking pins 1451 and 1452 can be biased or pressed inward, and pole 1410 can be pulled out of pole 1460.

Pole 1460 has a third locking mechanism 1470 that is identical to the first and second locking mechanisms 1425 and 1450. Locking mechanism 1470 has locking pins 1471 and 1472 that protrude from holes 1417 and 1418 located on opposite surfaces of pole 1460, and near the second end 1462 of pole 1460. Locking pins 1471 and 1472 are able to be biased inward towards the center of pole 1460, so that pole 1460 can be inserted into attachment 1480. Attachment 1480 has holes 1483 and 1484, a first end 1481 and a second end 1482. When the second end 1462 of pole 1460 is fully inserted into the first end 1481, the locking pins 1471 and 1472 are able to return back to their original unbiased positions and protrude through openings 1484 and 1483 of attachment 1480, thereby locking pole 1460 and attachment 1480 together. To release pole 1460 from attachment 1480, locking pins 1471 and 1472 can be biased or pressed inward, and pole 1460 can be pulled out of attachment 1480.

Referring to FIG. 29, attachment mechanism 1430 is shown. Attachment mechanism 1430 is able to slide towards and away from cage 1120, while contained in pole 1410. Center rod 1433 runs through pole piece 1435 and can connect to one or more pulley cables. In a preferred embodiment, center rod 1433 is can connect with four pulley cables in the body cavity of pole piece 1435.

Referring to FIG. 30, an embodiment of the first pole 1410 is shown. Holes 1414 and 1413 are 10 millimeters (mm) away from the first end 1411, and both have a radius of 7 (mm). Slots 1441 and 1440 have a first rounded end 1442 and a second rounded end 1443. Second rounded end 1443 has a radius of 3.25 (mm) and is 70 (mm) away from first end 1411. First rounded end 1442 has a radius of 3.25 (mm) and is 95 (mm) away from first end 1411. Slots 1441 and 1440 both have length of 25 (mm) from end to end and have a width of 6.5 (mm). Holes 1416 and 1415 are 25 (mm) away from the second end 1412, and both have a radius of 7 (mm).

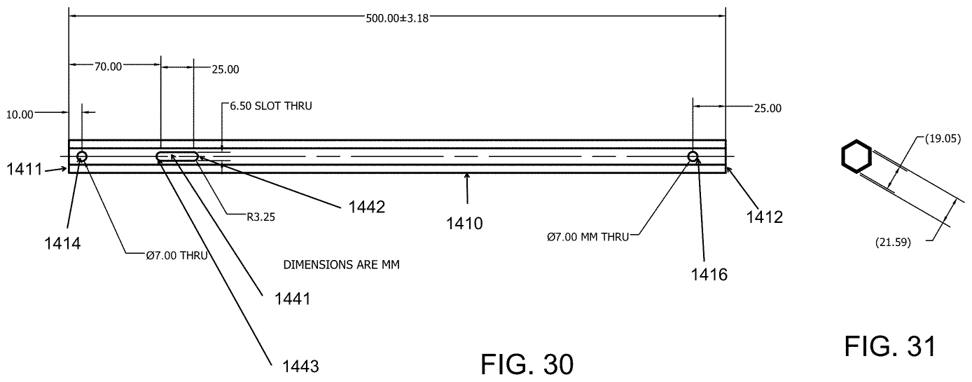

Referring to FIGS. 30-31, first pole 1410 is hollow and has an outer diameter or width of 21.59 (mm) and an inner diameter or width of 19.05 (mm), and a total length of 500 (mm).

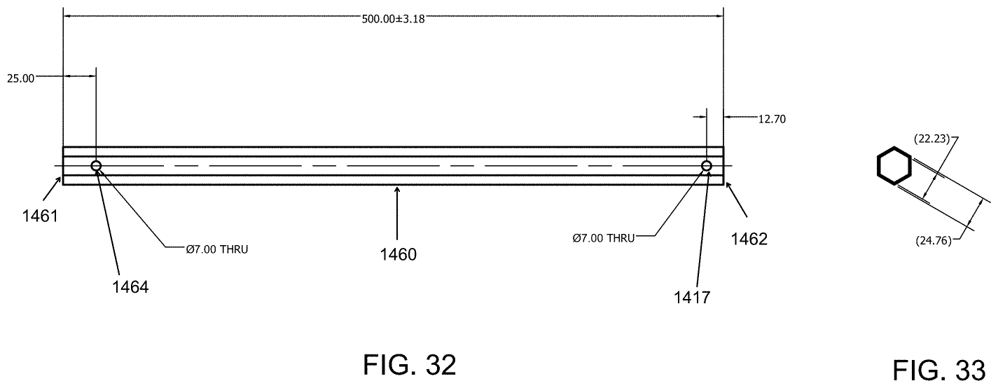

Referring to FIG. 32, an embodiment of the second pole 1460 is shown. Holes 1464 and 1463 are 25 (mm) away from the first end 1461, and both holes have a radius of 7 (mm). Holes 1417 and 1418 are 12.7 (mm) away from the second end 1462, and both have a radius of 7 (mm).

Referring to FIGS. 32-33, second pole 1460 is hollow and has an outer diameter of 24.76 (mm) and an inner diameter of 22.23 (mm), and a total length of 500 (mm).

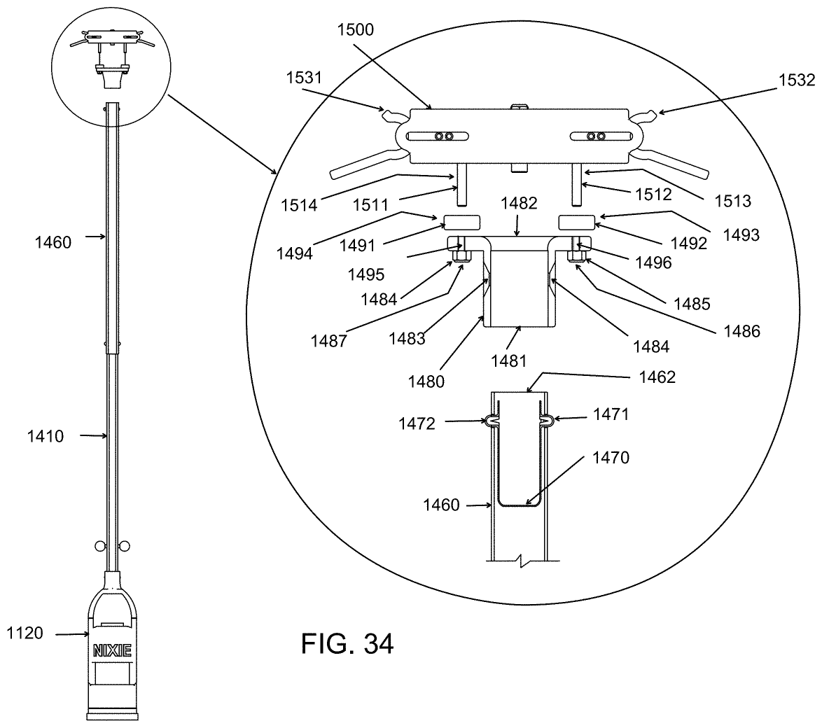

Referring to FIGS. 34, 35, 36 and 40, device adaptor 1500 is connected to attachment 1480 by bolts 1511, 1512, 1513 and 1514, that pass through holes 1501, 1502, 1503 and 1504, respectively, in adaptor 1500, and through individual dampers 1491, 1492, 1493, and 1494 and pass through holes 1495, 1496, 1497 and 1498, respectively, in attachment 1480, and are connected to and secured by nuts 1484, 1485, 1486 and 1487, respectively.

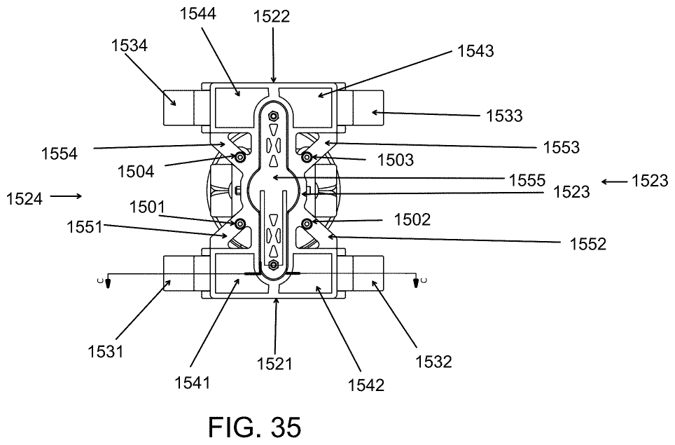

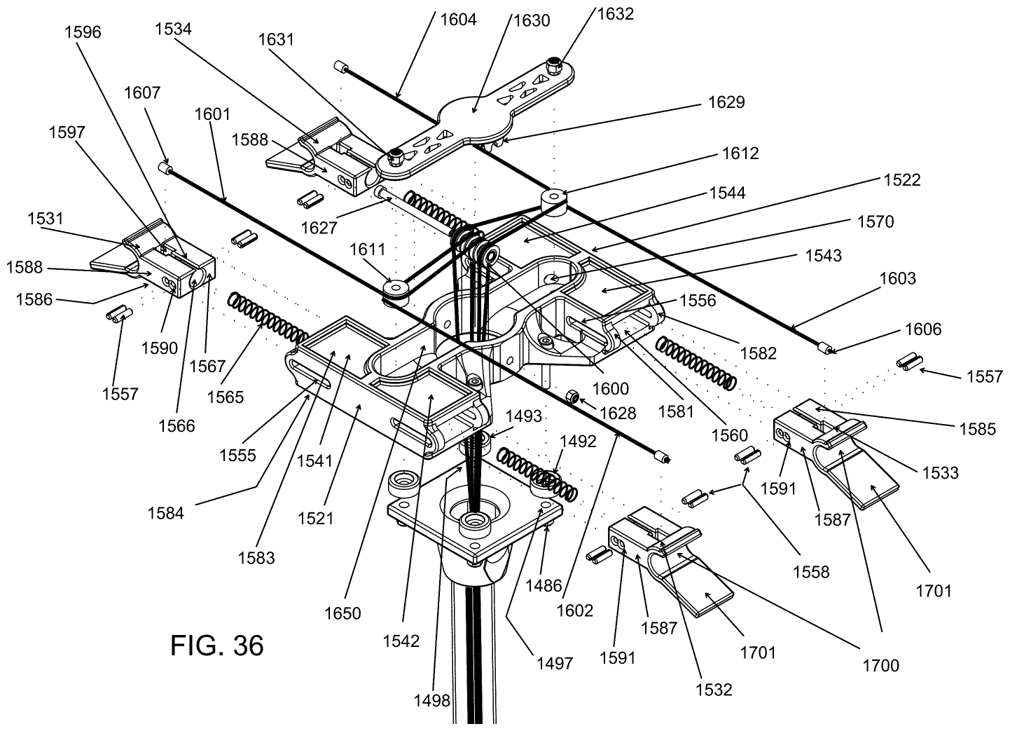

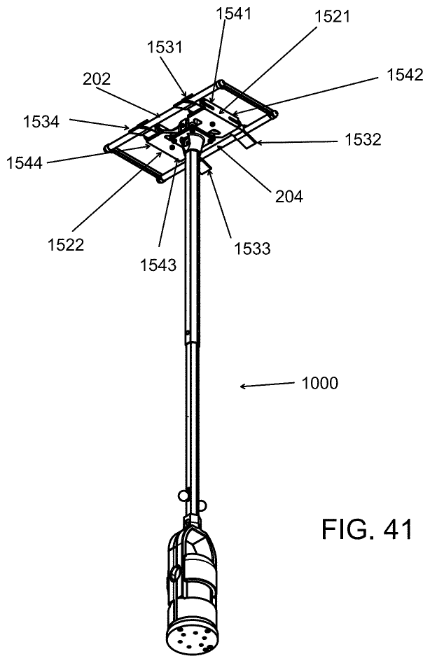

Referring to FIGS. 35, 36 and 41, device adaptor 1500 has arm attachment blocks 1531, 1532, 1533 and 1534 each having fastener portions 1700 that can attach to a UAV bar. Each fastener 1700 can be “C” shaped, so as to releasably snap fit to one of UAV bars 202 or 204. Arm attachment blocks 1531, 1532, 1533 and 1534 are housed respectively in compartments 1541, 1542, 1543 and 1544. Arm attachments 1531 and 1532, are able to attach by snap fit to first UAV bar 202, and arm attachments 1533 and 1534 are able to attach by snap fit to a second UAV bar 204 of UAV 200, as shown in FIG. 41. Device adaptor 1500 has a first side 1521, a second side 1522 and a middle section 1525. First side 1521 includes first and second compartments 1541 and 1542, that house arm blocks 1531 and 1532, respectively. The fastener portions 1700 of arm blocks 1531 and 1532 face opposite directions when arm blocks 1531 and 1532 are housed in compartments 1541 and 1542 respectively and are able to contact and connect to separate bars 202 and 204 respectively on UAV 200. First side 1521 is connected to second side 1522 by a middle section 1525 having a middle chamber 1650 that houses the pulley mechanism 1600, pulley cables 1601, 1602, 1603, and 1604, and rollers 1611 and 1612 as shown in FIG. 36. Second side 1522 includes third and fourth compartments 1543 and 1544, that house arm blocks 1533 and 1534 respectively. The fastener portions 1700 of arm blocks 1533 and 1534 face opposite directions when arm blocks 1533 and 1534 are housed in compartments 1543 and 1544 respectively and are able to contact and connect to separate bars 204 and 202 respectively on UAV 200. Together the fasteners 1700 of arm blocks 1531 and 1534 face the same direction, and together are able to snap fit and detachably connect to first bar 202 of UAV 200. Together the fasteners 1700 of arm blocks 1532 and 1533 face the same direction, and together are able to snap fit and detachably connect to second bar 204 of UAV 200. Device adaptor 1500 has a first side 1521, a second side 1522, a third side 1523 and a fourth side 1524 as shown on FIG. 35.

Device adaptor 1500 has braces 1551, 1552, 1553, and 1554 that each attach from a first end, to either a first or second side 1521 and 1522 as shown and attach on a second end to the middle portion 1525. The braces 1551, 1552, 1553, and 1554 provide added rigidity to the adaptor 1500. Triangularly shaped holes between each of the braces 1551, 1552, 1553, and 1554 and the middle portion 1525 ensure that additional weight is not added to device adaptor 1500.

Each of compartments 1541, 1542, 1543 and 1544 have inner walls 1581 and outer walls 1582, and top and bottom walls 1583 and 1584, that together each define a cavity 1560. Each cavity 1560 of each compartment 1541, 1542, 1543 and 1544 provides space to house one of the arm attachment blocks 1531, 1532, 1533 and 1534. Inner walls 1581 face towards center portion 1525, while outer walls 1582 face away from center portion 1525. Top walls 1583 face UAV 200, while bottom walls 1584 face cage 1120. Inner walls 1581 have compartment slots 1556, and outer walls 1582 have compartment slots 1555. Slots 1555 and 1556 are identical and placed on opposing walls 1582 and 1581 with respect to each other.

Arm attachment blocks 1531, 1532, 1533 and 1534 are all identical to each other. Each of the attachment blocks 1531, 1532, 1533 and 1534 have an upper surface 1585 and an opposing lower surface 1586, and first and second opposing side surfaces 1587 and 1588. When arm attachment blocks 1531, 1532, 1533 and 1534 are placed in cavities 1560 of each compartment 1541, 1542, 1543 and 1544, upper surface 1585 faces towards UAV 200, and lower surface 1586 faces towards cage 1120. First and second side surfaces 1587 and 1588 each have a pair of circular recesses 1591 and 1590 in attachment blocks 1531, 1532, 1533 and 1534 that are able to house and retain portions of cylindrical pin pairs 1558 and 1557. Each arm attachment block 1531, 1532, 1533 and 1534 has a cylindrical cavity 1566, having a circular opening on inner surface 1567 of each attachment block. Inner surface 1567 of each attachment block is the surface that is first loaded into each cavity 1560 when the attachment blocks are housed in each compartment 1541, 1542, 1543 and 1544. A spring 1565 is housed in each cylindrical cavity 1566 of each arm attachment block 1531, 1532, 1533 and 1534. Each spring 1565 when loaded into an arm block that is then installed in a chamber of the device adaptor, is compressed between the arm block and an interior wall 1599 of each chamber, and thereby provides a biasing force against each arm block as shown in FIG. 38.

Each cylindrical cavity 1567 has a circular opening with a diameter that is greater than the diameter of the coils of each of springs 1565. The top surface 1585 of each attachment block 1531, 1532, 1533 and 1534, has two rectangularly shaped openings 1596 and 1597, that provide access to each cylindrical cavity 1566, so that pulley cables 1601, 1602, 1603 and 1604 are able to be guided through the openings 1597 and 1596 and become retained and held in cylindrical cavity 1566. Opening 1597 is wider than opening 1596, and also wider than retaining end 1607. Opening 1596 is wider than each pulley cable 1601, 1602, 1603 and 1604. Each pulley cable 1601, 1602, 1603 and 1604 is able be routed lengthwise through a center of each spring 1565.

Each of compartments 1541, 1542, 1543 and 1544 have a hole or recess 1570 which provides access from middle chamber 1650 to each compartment for each of pulley cables 1601, 1602, 1603, and 1604. Chamber 1650 has a hollow portion that provides a hole or entry at a bottom portion of adaptor 1500, which allows pulley cables 1601, 1602, 1603 and 1604 to be guided through hollow tubes 1410, 1460, and through attachment 1480 and into adaptor 1500. Pulley cables 1601, 1602, 1603 and 1604 are then guided and placed onto pulley mechanism 1600, housed in chamber 1650, as shown in FIGS. 36, 37 and 40.

Referring to FIGS. 36-40, pulley cables 1601, 1602, 1603 and 1604 each have first ends 1605 and second ends 1606. The first end 1605 of each pulley cable is connected to or tied to center rod 1433 of attachment mechanism 1430. Each second end 1606 of each cable is connected to a retaining end 1607. Retaining end 1607 can be cylindrical in shape. Retaining ends 1607 are able to fit into openings 1597 in each attachment arm, and each pulley cable is meant to be able to fit into opening 1596. Each pulley cable 1601, 1602, 1603 and 1604 is able to be routed through the hollow internal portion of poles 1410 and 1460, through attachment 1480 and into compartment 1650 of adaptor 1500.

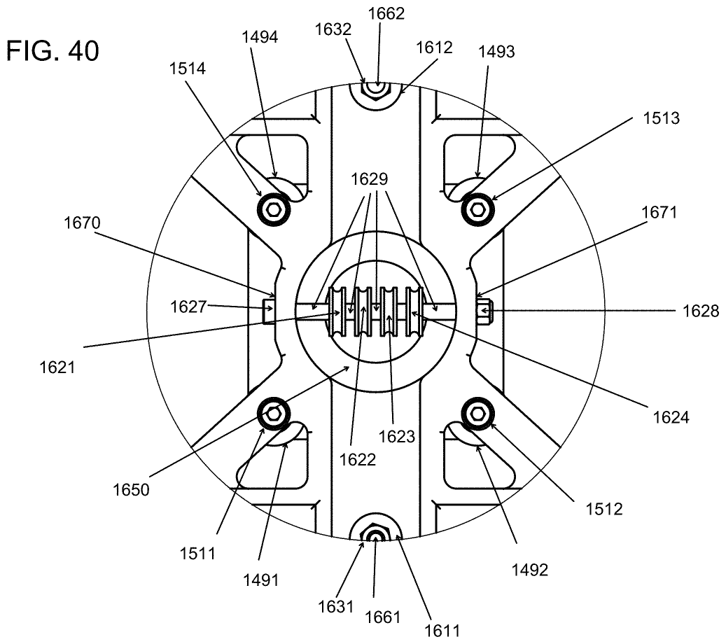

Pulley mechanism 1600 includes a bolt 1627, and pulleys 1621, 1622, 1623 and 1624 and nut 1628. Bolt 1627 runs through a hole 1670 in the center portion 1525, through the center of pulleys 1621, 1622, 1623 and 1624 and out through another hole 1671 in center portion 1525 as shown in FIG. 40. Bolt 1627 is secured to adaptor 1500 by nut 1628. Pulleys 1621, 1622, 1623 and 1624 are able to rotate when mounted on bolt 1627. Each of pulley cables 1601, 1602, 1603 and 1604 are mounted on one of pulleys 1621, 1622, 1623 and 1624, and are able to freely move along with the rotation of each pulley. Pulleys 1621, 1622, 1623 and 1624 are able to change the direction of the force applied on the cables 1601, 1602, 1603 and 1604 from a vertical plane to a horizontal plane. The vertical plane is defined as being a plane parallel to the length wise dimension of pole assembly 1400, and the horizontal plane is defined as being perpendicular to the vertical plane. Pulley mechanism 1600 when installed is located at the center of center portion 1525 of adaptor 1500.

In some embodiments, when pulley cables 1601 and 1602 are placed onto pulley mechanism 1600 in order to be routed to a first side 1521, cables 1601 and 1602 can be guided onto either the two internally situated pulleys 1622 and 1623, or onto the two externally situated pulleys 1621 and 1624. Similarly, when pulley cables 1603 and 1604 are placed onto pulley mechanism 1600 in order to be routed to a second side 1522, cables 1603 and 1604 can guided onto either the two internally situated pulleys 1622 and 1623, or on the two externally situated pulleys 1621 and 1624. If one set of cables 1601 and 1602 are routed to a first side 1521, and use the internal pulleys 1622 and 1623, then cables 1603 and 1604 that are routed to the second side must use outer pulleys 1621 and 1624 or vice versa. FIG. 36 shows cables 1601 and 1602 routed over pulley mechanism 1600 towards a first side 1521, and being guided over internal pulleys 1622 and 1623, while cables 1603 and 1604 are routed towards the second side 1522 and guided over external pulleys 1621 and 1624.

Referring to FIGS. 36 and 40, rollers 1611 and 1612 are housed in compartment 1650 and secured to adaptor 1500 by bolts 1661 and 1662, and nuts 1631 and 1632, respectively. Nuts 1631 and 1632 connect to bolts 1661 and 1662 on the outside of cover 1630 through two holes in the cover. Cover 1630 covers compartment 1650 of adaptor 1500. Cover 1650 has a snap fit connector that releasably connects to portions 1629 of bolt 1627 that are not covered by pulleys 1621, 1622, 1623 and 1624.

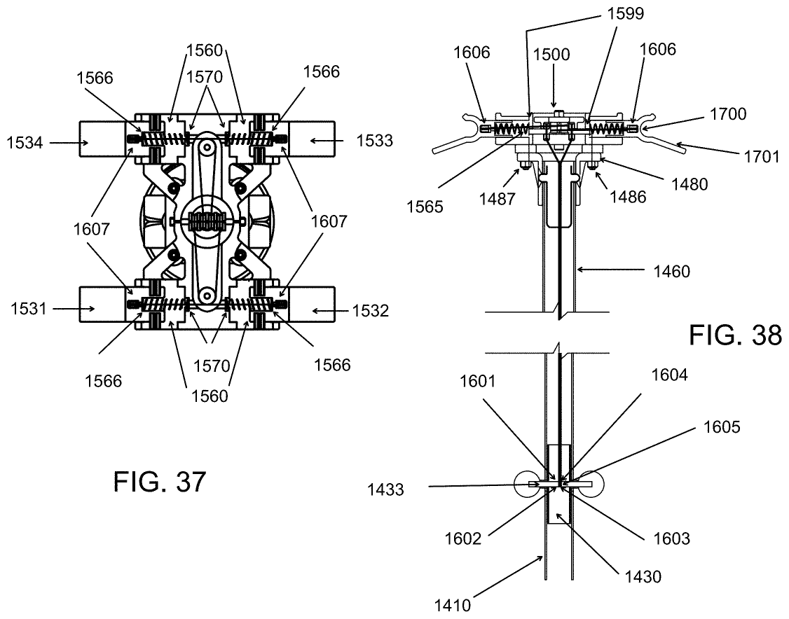

Two pulley cables 1601 and 1602 are guided around opposite ends of a roller 1611, towards first side 1521. Cable 1601 is guided through hole 1570 of compartment 1541, and through the center of a spring 1565, as shown in FIGS. 36-37. Cable 1602 is guided through hole 1570 of compartment 1542, and through the center of a spring 1565, as shown in FIG. 37. The remaining two pulley cables 1603 and 1604 are guided around opposite ends of a roller 1612 towards second side 1522. Cable 1603 is guided through hole 1570 of compartment 1543, and through the center of a spring 1565. Cable 1604 is guided through hole 1570 of compartment 1544, and through the center of a spring 1565.

Rollers 1611 and 1612 are able to change the direction of the force applied by the cables 1601, 1602, 1603 and 1604 by 90 degrees in the horizontal plane. For example, the initial force transmitted by pulley cable 1601 is vertical within pole assembly 1400, then pulley mechanism 1600 changes the direction of the force transmitted by cable 1601 to a horizontal orientation. Roller 1611 is then able to change the direction of the force by 90 degrees in the horizontal plane so that the direction of the force transmitted by pulley cable 1601 is directed away from arm block 1531. Therefore, when pulley cable 1601 is installed in arm block 1531, and arm block 1531 is installed in chamber 1541, cable 1601 is able to pull arm block 1531 towards the interior of cavity 1560, when a force is applied. Cable 1602 is wrapped around roller 1611 in an opposite direction from cable 1601 and can similarly pull arm block 1532 further into cavity 1560 when arm block 1532 is installed in chamber 1542. Roller 1612 similarly allows pulley cables 1603 and 1604 to pull arm blocks 1533 and 1534 into cavities 1560 of chambers 1543 and 1544 respectively.

Retaining end 1607 of each cable is placed into opening 1597 of each arm block. The retaining end 1607 of each cable is then retained by each cylinder cavity 1566 of each arm block, along with each spring 1565. When fully assembled each arm block 1531, 1532, 1533 and 1534 along with its respective cables 1601, 1602, 1603 and 1604, and springs 1565 are retained in one the of compartments 1541, 1542, 1543 and 1544. Pin pairs 1557 are then installed into circular recesses 1590 through slots 1555, and pin pairs 1558 are installed in circular recesses 1591 through slots 1556, thereby preventing each block arm from being forced out of each cavity 1560, by the biasing force of each spring 1565. Each block arm 1531, 1532, 1533 and 1534 is able to move towards the interior and also move towards the exterior of each cavity 1560 of each compartment. Pin pairs 1557 and 1558 restrict the maximum distance each arm block may travel towards the exterior or interior of each compartment, as the pin pairs 1557 and 1558 are halted by the size of the slots 1556 and 1555.

When device 1000 is fully assembled, each block arm 1531, 1532, 1533 and 1534 is biased by springs 1565 towards the exterior of each compartment 1541, 1542, 1543 and 1544, respectively, so that each cable 1601, 1602, 1603 and 1604 becomes taut and center arm 1433 of attachment mechanism 1430 comes to rest in a first position adjacent to curved portion 1442 of slots 1441 and 1440. Each of arm blocks 1531, 1532, 1533 and 1534 are securely retained in a fully extended position in cavity 1560 of each compartment 1541, 1542, 1543 and 1544 respectively, with pin pairs 1557 and 1558 being retained by slots 1555 and 1556.

When a user provides enough force to move center arm 1433 from its first position into a second position that is adjacent to curved portion 1443 of slots 1441 and 1440, each cable 1601, 1602, 1603, and 1604 overcomes the biasing force of each spring 1565, so that each block arm 1531, 1532, 1533 and 1534 retracts towards the interior of each compartment 1541, 1542, 1543 and 1544, respectively. Referring to FIGS. 23 and 29, a user can transmit the required force with one hand to retract each block 1531, 1532, 1533 and 1534 into each cavity 1560, by placing a finger underneath connector 1155 of cage 1120 at a portion 1156, and place a finger on each grip 1431 and 1432 of mechanism 1430. The user can then squeeze their fingers together to move mechanism 1430 from a first position at curved portion 1442 to a second position at curved portion 1443, to retrack the arm blocks.

Referring to FIGS. 36 and 41, each arm block 1531, 1532, 1533 and 1534 has a fastener portion 1700 that is able to releasably detach from a UAV bar 202 or 204. In some embodiments, fastener portion 1700 also has a guide extension 1701 that protrudes from the lower portion of fastener 1700. The lower portion of faster 1700 being the portion that is adjacent to lower surface 1586 of each attachment block. Extension guide 1701 protrudes out further than fastener 1700 and is the first portion of each arm block 1531, 1532, 1533 and 1534 to come into contact with UAV bars 202 and 204, when a user is connecting water sampling device 1000 to UAV 200. Extension guide 1701 is angled downward so that when a user releases the locking mechanism 1430 from a second position back its first position, the biasing of springs 1565 push arm blocks 1531, 1532, 1533 and 1534 outward toward the UAV bars 202 and 204, the bars travel upward along extension guide 1701 and into fasteners 1700. The springs 1565 are able to overcome the bias of materials of fasteners 1700 so that fasteners 1700 releasably snap fit onto bars 202 and 204.

Referring to FIG. 41, arms 204 and 202 of UAV 200 are shown disconnected from UAV 200, for the purpose of illustrating how device 1000 connects to UAV 200. Arms 202 and 204 will be connected to UAV 200, when device 1000 is being connected to UAV 200. When UAV 200 hovers above a user, the user will grab the fully assembled device 1000, and move mechanism 1430 as described above from a first position down to a second position and hold the mechanism at the second position. With each of the arm blocks 1531, 1532, 1533 and 1534 retracted, the user will lift device 1000 closer to the bottom of UAV 200, so as to ensure each fastener is relatively adjacent to arm bars 202 and 204. Then, the user will release the mechanism 1430 so that it travels back to its first position, thereby causing the arm blocks to extend. When the arms fully extend and fasteners 1700 meet arm bars 202 and 204, the force of each spring 1565, overcomes the bias of materials of each fastener 1700, so that each fastener 1700 temporarily expands to receive and attach to one of bars 202 or 204. The force of the springs 1565, along with the shape of the fasteners 1700 keep the arm blocks 1531, 1532, 1533 and 1534 securely attached to the arm bars 202 and 204 of UAV 200, until a user grabs device 1000, and applies a force to mechanism 1430 to move the mechanism from the first position to a second position. When a user moves the mechanism from the first position to a second position, the user must apply enough force to overcome the biasing force of each spring 1565, and the bias of materials of each fastener 1700, so that the each fastener temporarily expands to release each of bars 202 and 204. A user is able to quickly attach or release device 1000 from underneath a UAV 200, while the UAV 200 is hovering above the user.

Accordingly, no screws, bolts or the like are needed to connect water sampling device 1000 to UAV 200. If UAV 200 did not have first bar 202 and second bar 204, then UAV can be subsequently modified to include first bar 202 and second bar 204.

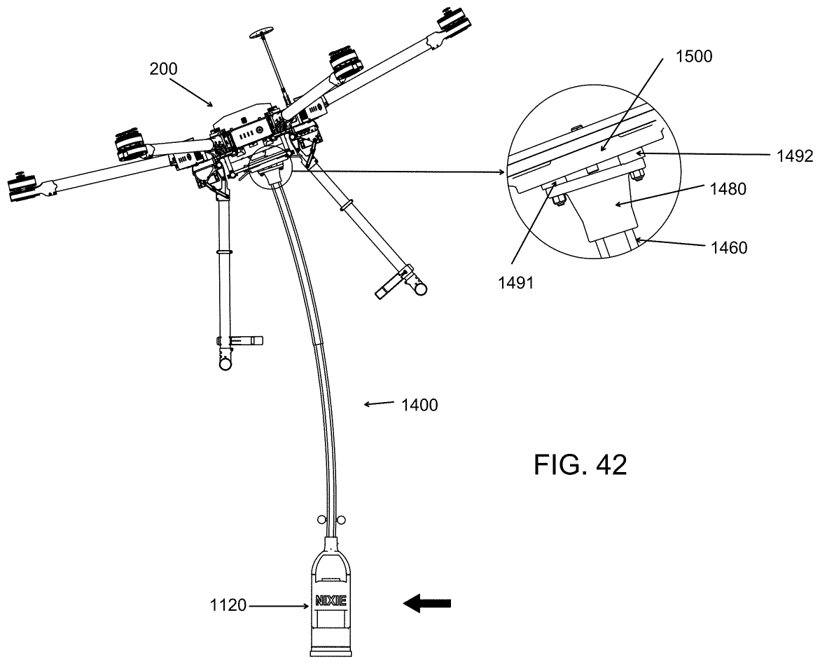

Referring to FIGS. 21 and 42, water sampling device 1000 is designed to plunge below the surface of a liquid reservoir because it is important not to gather the surface water for most water sampling testing. Other water sampling devices have not been able to offset buoyancy or negatively affect pitch, roll and yaw of the UAV poorly. These other devices simply float on the water which is undesirable. Water sampling device 1000, besides for offsetting buoyancy, also balances weight on UAV 200 properly. As discussed above, water sampling is a relatively simple mission for UAVs. However, after some tests, it shows that an empty water sampling vessel creates force (buoyancy) that is affecting the UAV dynamics and might risk the operation. For reference, using a 500 mL sampling bottle 1110 and a 1 meter pole for assembly 1400, will force the UAV to Roll compensate for 3.5-5 Nm. To solve this problem, the mass of water sampling device 1000 should be slightly higher than the buoyancy force. Roll is one of the forces in aerodynamics. Pitch, Roll and Yaw, are also known as the “Principal Axes” or “Axes of Rotation”, that include: Lateral Axis (Pitch), Longitudinal Axis (Roll) and Vertical Axis (Yaw). It is important that the UAV, with water sampling device 1000, not compromise the flying safety (pitch, roll, yaw) of the drone.

When device 1000 is connected or attached to UAV 200, and is submerged in a liquid reservoir 300, the liquid can subject the device 1000, including bottle 1110, cage 1120 and pole assembly 1400, to forces that destabilize and negatively affect the flying dynamics of UAV 200. In order to counteract this, UAV 200 can minimally tilt in the same direction of the destabilizing force, so that pole assembly 1400 bends towards the direction of the destabilizing force, and thereby creates a counteracting force in a pole assembly 1400, in a direction that opposes the destabilizing force created by the liquid. This can be seen in FIG. 42, which shows an exaggerated tilting of UAV 200, and an exaggerated bend in pole assembly 1400 for purposes of illustration. This movement allows bottle 1110 to settle again in a stable center of gravity and restores control to UAV 200.

When UAV 200 tilts to either direction, either due to corrective tilt during flight by UAV 200 or when contact with water causes the device 1000 to be subjected to forces, dampers 1491, 1492, 1493 and 1494 are able to compress and expand as needed as shown in FIG. 42, so that some of the forces are absorbed, providing added flight stability to UAV 200, and thereby ensuring the safe and proper collection of a water sample by device 1000.

Referring to both device 100 and device 1000, both water sampling devices are compatible with a Matrice UAV. Water sampling device 1000 and/or 1000 can be used on different UAVs 200. As long as these different UAVs can carry the payload weight of water sampling device 100 or 1000 and has the landing bars, namely, first bar 202 and second bar 204, on the bottom, water sampling device 100 and/or 1000 can be customized to other UAVs. However, flight testing may still need to be conducted with a different UAV connected to water sampling device 100 or 1000 beforehand for safety reasons.

In some embodiments, device 100 and 1000 can be sanitized prior to use, so that water samples collected by the devices are not contaminated.

Adaptor 500 and 1500 can be used to be interchangeably for some other industrial uses besides for water sampling. For example, adaptor 500 and/or 1500 when connected to UAV 200 can be used to sample water having mosquito and/or mosquito larva for testing. Another example, adaptor 500 and/or 1500 when connected to UAV 200 can be used to sample water in highly contaminated areas so that the user does not have to be exposed to the highly contaminated areas.

Water sampling device 100 or 1000 can be bright pink or safety orange or another bright color. The color should not be common in nature so that you can see water sampling device 100 or 1000 from a distance. The various components of the devices can be bright colors such as bright pink or safety orange, including the bottle, bottle cage, and device adaptors.

Water sampling device 100 and 1000 has components that, for example, can be 3D printed. For example, adaptor body 502 can be 3D printed.

Testing shows that samples can be collected by water sampling device 100 and/or 1000 four times more quickly over earlier techniques. For example, techniques that require people in a boat to collect water samples with gloved arms can lead to contamination and require an undesirable amount of labor. Water sampling device 100 and 1000 saves costs over this type of water sampling as well.

UAV 200 connected to water sampling device 100 or 1000 can also automatically document a location where a water sample is taken. Further, a camera can be connected to water sampling device 100 and 1000.

Devices 100 and 1000 can be easily assembled and dismantled into the main component pieces such the device adaptors, individual pole assembly pieces, bottles and cages, so as to enable easy storage, transport and packaging of the device.

Devices 100 and 1000 can also be used to collect samples of liquids other than water.

In some embodiments, the bottles of devices 100 and 1000 can be directly connected to the pole assemblies so that a bottle cage is not needed to collect the liquid samples. In some embodiments devices 100 and 1000 can be connected to different attachments other than a bottle cage or bottle, for use in other tasks beyond liquid collection and sampling, such as a hook or other container can be attached to the pole assemblies.

With regards to devices 100 and 1000, some embodiments are envisioned in which different numbers of arm blocks and fasteners may be used to connect to UAV bars 202 and 204, although preferred embodiments have four arm blocks with four fasteners. In some embodiments, the device 100 and 1000 can work with as few as two fasteners, with one fastener on each side of the device, each connecting to one of UAV bars 202 and 204.

While the present disclosure has been described with reference to one or more exemplary embodiments, it will be understood by those skilled in the art, that various changes can be made, and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure will not be limited to the particular embodiments disclosed herein, but that the disclosure will include all aspects falling within the scope of a fair reading of appended claims.

What is claimed is:

1. A liquid collection device for use with an unmanned aerial vehicle, the device comprising:
a bottle cage for receipt of a bottle therein,
a pole assembly,
a device adaptor having a plurality of fasteners,
wherein the bottle is removably secured in the bottle cage when the device is in use,
wherein the pole assembly has a top portion and a bottom portion, and the bottom portion is connected to the bottle cage,
wherein the top portion of the pole assembly is connected to a bottom portion of the device adaptor.

2. The liquid collection device of claim 1, wherein the plurality of fasteners have two halves with a first half of the plurality of fasteners located on a first side of the device adaptor and a second half of the plurality of fasteners located on a second side of the device adaptor, and
wherein the first side and second of the device adaptor are separated by a middle portion of the device adaptor.

3. The liquid collection device of claim 1, wherein the bottle is removably secured in the bottle cage by being loaded into the cage from a bottom opening of the bottle cage.

4. The liquid collection device of claim 1, wherein the plurality of fasteners have two halves with a first half of the plurality of fasteners being fixed to the device adaptor and a second half of the plurality of fasteners being retractable, and wherein the device adaptor has a plurality of chambers for housing the retractable half of the plurality of fasteners so that the retractable fasteners are able to retract into the chambers.

5. The liquid collection device of claim 3, wherein the bottle cage has a retractable tab located at the bottom opening of the bottle cage that is pulled out to secure the bottle once the bottle loaded into the bottle cage.

6. The liquid collection device of claim 4, wherein the device adaptor has a first side and a second side and the first side and the second of the device adaptor are separated by a middle portion of the device adaptor; and
wherein the chambers are located on a fourth side of the device adaptor opposite a third side of the device adaptor and the fixed fasteners are located on the third side.

7. The liquid collection device of claim 6, wherein the device adaptor has springs for biasing each of the retractable fasteners out of the compartments,
wherein the retractable fasteners are each secured to the chambers by a retaining pin so that the springs do not force the fasteners completely out of the chambers, and
wherein each spring produces the biasing force by being compressed between the retractable fasteners and an inner wall of each chamber.

8. The liquid collection device of claim 1, wherein the device adaptor has a total of four fasteners.

9. The liquid collection device of claim 1, wherein the pole assembly is cylindrical or hexagonal.

10. The liquid collection device of claim 1, wherein the plurality fasteners are C shaped.

11. The liquid collection device of claim 1, wherein the bottle cage and device adaptor is bright pink or safety orange.

12. A liquid collection device for use with an unmanned aerial vehicle, the device comprising:
a bottle cage for receipt of a bottle therein,
a hollow pole assembly,
an attachment mechanism having a center arm able to move from a first position to a second position within the pole assembly,
a plurality of cables each having a first end and a second end,
a pulley mechanism having pulleys and rollers,
a plurality of arm blocks each having a fastener on a first end thereof,
a spring for each of the arm blocks,
a device adaptor having chambers for each of the arm blocks and a center chamber housing the pulley mechanism and the rollers,
wherein the bottle is removably secured in the bottle cage,
wherein the hollow pole assembly has a top portion and a bottom portion, and the bottom portion is connected to the bottle cage,
wherein the top portion of the hollow pole assembly is connected to a bottom portion of the device adaptor,
wherein half of the chambers of the device adaptor are on a first side of the device adaptor, and the other half of the chambers are on a second side of the device adaptor,
wherein each of the arm blocks are housed in each chamber of the device adaptor so that a second end of each of the arm blocks that is opposite the first end, is adjacent to an internal wall of each chamber,
wherein the first end of each cable is connected to the center arm in the pole assembly,
wherein each cable is guided through the hollow pole assembly and onto one of the pulleys and one of the rollers and into one of the chambers,
wherein the second end of each cable is connected to one of each of the arm blocks,
wherein each spring is housed in each of the arm blocks and is compressed between each of the arm blocks and each internal wall of each of the chambers thereby providing a biasing force against each arm block, and
wherein due to the biasing force on each of the arm blocks, each cable is pulled taut so that the center arm of the attachment mechanism comes to rest at a first position in the hollow pole assembly.

13. The liquid collection device of claim 12, wherein the bottle cage includes a cage door that can be opened to load the bottle into the bottle cage and can be securely closed to retain the bottle in the bottle cage.

14. The liquid collection device of claim 12, wherein the fasteners are C shaped.

15. The liquid collection device of claim 12, wherein the fasteners each have guide extensions.

16. A method of attaching the device of claim 12 onto an unmanned aerial vehicle, the steps comprising:
applying a force to move and hold the center arm of the attachment mechanism from the first position into the second position, thereby overcoming the biasing force on each of the arm blocks, causing each of the arm blocks to retract into each of the chambers;
moving the device or the unmanned aerial vehicle into a position relative to each other so that half of the fasteners of the device are adjacent to a first unmanned aerial vehicle bar and the other half of the fasteners of the device are adjacent to a second unmanned aerial vehicle bar;
removing the force on the center arm so that the center arm of the attachment mechanism moves back to rest at the first position in the hollow pole assembly thereby allowing the biasing force of each spring to extend the arm blocks so that half of the fasteners attach to the first bar and the other half of the fasteners attach to the second bar,
wherein the first and second unmanned aerial vehicle bars are both connected to the unmanned aerial vehicle.

17. A method of removing the device of claim 12 from an unmanned aerial vehicle, the steps comprising:
applying a force to move and hold the center arm of the attachment mechanism from the first position into the second position, thereby overcoming the biasing force on each of the arm blocks, causing each of the arm blocks to retract into each of the chambers, and
thereby causing the fasteners to release a first unmanned aerial vehicle bar and a second unmanned aerial vehicle bar that are both connected to the unmanned aerial vehicle.

18. A method of collecting liquid samples using the device of claim 12, the steps comprising:
attaching the device to an unmanned aerial vehicle,
flying the unmanned aerial vehicle to a target location with a liquid reservoir, and
lowering the unmanned aerial vehicle so that an opening of the bottle that is removably secured in the bottle cage is submerged below a surface of the liquid reservoir, so that the liquid sample is collected and retained in the bottle.

19. The method of claim 16, further comprising the step of applying the force by using one hand of a user,
wherein a first finger of the hand is placed under a pole assembly connection portion of the bottle cage, and a second and a third finger are each placed on the center arm, and
wherein the first finger is squeezed towards the second and third fingers, so that the center arm moves from the first position to the second position.

20. The method of claim 17, further comprising the step of applying the force by using one hand of a user,
wherein the hand has a first finger that is placed under a pole assembly connection portion of the bottle cage, and a second and a third finger are each placed on the center arm, and
wherein the first finger is squeezed towards the second and third fingers, so that the center arm moves from the first position to the second position.
